(19) United States
(12) Patent Application Publication
(10) Pub. No.: US 2025/0102717 A1
(43) Pub. Date: Mar. 27, 2025

(54) OPTICAL STRUCTURE, MANUFACTURING METHOD THEREOF AND DISPLAY DEVICE

(71) Applicants: Beijing Zitiao Network Technology Co., Ltd., Beijing (CN); Lemon Inc., Grand Cayman (KY)

(72) Inventors: Shaopeng ZHU, Beijing (CN); Ziyang ZHANG, Los Angeles, CA (US); Jian CHEN, Beijing (CN); Ling FU, Beijing (CN); Wenbin BAI, Beijing (CN)

(21) Appl. No.: 18/894,792

(22) Filed: Sep. 24, 2024

(30) Foreign Application Priority Data
Sep. 25, 2023 (CN) 202311238187.4

(51) Int. Cl. G02B 5/30; G02B 17/08

(52) U.S. Cl. CPC G02B 5/3025; G02B 17/0856

(57) ABSTRACT

An optical structure, a manufacturing method thereof and a display device. The optical structure has a light incident side and a light-exiting side, the optical structure includes a first lens, a transflective film, a phase retardation layer, and a polarizing reflective film. The first lens includes a first surface and a second surface, the phase retardation layer is located on a side of the second surface away from the first surface, the phase retardation layer includes an alignment layer and a liquid crystal layer, the manufacturing method includes: coating the alignment layer on the second surface of the first lens; using an alignment light source to optically align the alignment layer from the light incident side; coating the liquid crystal layer on a side of the alignment layer away from the second surface.

### CROSS-REFERENCE TO RELATED APPLICATION

The present application claims priority of Chinese Patent Application No. 202311238187.4, filed on Sep. 25, 2023, the disclosure of which is incorporated herein by reference in its entirety as part of the present application.

### TECHNICAL FIELD

Embodiments of the present disclosure relate to an optical structure, a manufacturing method thereof and a display device.

### BACKGROUND

In virtual reality (VR) and mixed reality (MR) devices, a near-eye display device magnifies an image of a display screen through a lens to obtain a sense of immersiveness. At present, there are two main lens technologies: fresnel lens and ultra-short focal folded optical path (pancake) lens, the ultra-short focal folded optical path (pancake) lens greatly reduces the required distance between the near-eye display device and the human eye by folding the optical path, thereby making the VR device and the MR device thinner and thinner.

### SUMMARY

At least one embodiment of the present disclosure provides a manufacturing method of an optical structure, the optical structure has a light incident side and a light-exiting side, the optical structure includes a first lens, a transflective film, a phase retardation layer, and a polarizing reflective film, the first lens includes a first surface and a second surface which are oppositely disposed, the first surface is a surface of the first lens on the light incident side and the first surface is a curved surface, the transflective film is located on a side of the first surface away from the second surface, the phase retardation layer is located on a side of the second surface away from the first surface, and the polarizing reflective film is located on a side of the phase retardation layer away from the first surface, the phase retardation layer includes an alignment layer and a liquid crystal layer, the manufacturing method includes: coating the alignment layer on the second surface of the first lens; using an alignment light source to optically align the alignment layer from the light incident side; and coating the liquid crystal layer on a side of the alignment layer away from the second surface.

For example, in the manufacturing method of the optical structure according to an embodiment of the present disclosure, when the optical structure is applied to a display device, a display screen is provided on the light incident side of the optical structure, and the optical structure includes a focal point located at a position where the display screen is located, using the alignment light source to optically align the alignment layer from the light incident side includes: using the alignment light source to emit light from a plane where the focal point is located to optically align the alignment layer, wherein the plane is perpendicular to an optical axis of the first lens.

For example, in the manufacturing method of the optical structure according to an embodiment of the present disclosure, a light-exiting surface of the alignment light source is located in the plane where the focus point is located, and a dimension and shape of the light-exiting surface of the alignment light source are the same as those of a light-exiting surface of the display screen.

For example, in the manufacturing method of the optical structure according to an embodiment of the present disclosure, an area of a light-exiting surface of the alignment light source is smaller than an area of an orthographic projection of the phase retardation layer on the plane.

For example, in the manufacturing method of the optical structure according to an embodiment of the present disclosure, using the alignment light source to optically align the alignment layer from the light incident side includes: performing optically alignment on the alignment layer from the light incident side by linearly polarized light emitted by the alignment light source, a part of the linearly polarized light whose propagation direction coincides with an optical axis of the first lens has a first polarization direction, the first polarization direction is perpendicular to the optical axis, in a plane formed by the first polarization direction and a direction in which the optical axis is located, an included angle between the polarization direction of the linearly polarized light incident on the alignment layer and the optical axis becomes smaller and smaller from a central region to an edge region of the first lens.

For example, in the manufacturing method of the optical structure according to an embodiment of the present disclosure, an included angle between a long axis direction of a liquid crystal molecule of the liquid crystal layer and a tangent plane at a position of the liquid crystal molecule on the second surface is in a range from 0 to 40 degrees.

For example, in the manufacturing method of the optical structure according to an embodiment of the present disclosure, an average thickness of the alignment layer is in a range from 30 to 200 nm, and an average thickness of the liquid crystal layer is in a range from 1 to 5 μm.

For example, in the manufacturing method of the optical structure according to an embodiment of the present disclosure, the second surface of the first lens includes a curved surface or a planar surface.

For example, the manufacturing method of the optical structure according to an embodiment of the present disclosure further including: forming the transflective film on the first surface of the first lens; forming the polarizing reflective film on a side of the liquid crystal layer away from the first surface; forming a polarizing absorbing layer on a side of the polarizing reflective film away from the first surface; and forming a first antireflection layer on a side of the polarizing absorbing layer away from the first surface.

For example, the manufacturing method of the optical structure according to an embodiment of the present disclosure further including: providing a second lens and a third lens; forming a second antireflection layer on a side of the second lens; forming the transflective film on the first surface of the first lens; bonding a side of the first lens where the transflective film is formed with a side of the second lens where the second antireflection layer is not formed; forming a polarizing absorbing layer on a third surface of the third lens; forming the polarizing reflective film on a side of the polarizing absorbing layer away from the third surface; forming a third antireflection layer on a side of the third lens away from the third surface; and bonding a surface of the first lens where the liquid crystal layer is formed with a side of the third lens where the third antireflection layer is not formed.

At least one embodiment of the present disclosure provides a manufacturing method of an optical structure, wherein the optical structure has a light incident side and a light-exiting side, the optical structure includes a first lens, a transflective film, a phase retardation layer, and a polarizing reflective film, the first lens includes a first surface and a second surface which are oppositely disposed, the first surface is a surface of the first lens on the light incident side and the first surface is a curved surface, the transflective film is located on a side of the first surface away from the second surface, the phase retardation layer is located on a side of the second surface away from the first surface, and the polarizing reflective film is located on a side of the phase retardation layer away from the first surface, the phase retardation layer includes a liquid crystal layer, the manufacturing method includes: coating the liquid crystal layer on the second surface of the first lens; and using an alignment light source to optically align the liquid crystal layer from the light incident side.

For example, in the manufacturing method of the optical structure according to an embodiment of the present disclosure, when the optical structure is applied to a near-eye display device, a display screen is provided on the light incident side of the optical structure, and the optical structure includes a focal point located at a position where the display screen is located, using the alignment light source to optically align the liquid crystal layer from the light incident side includes: using the alignment light source to emit light from a plane where the focus point is located to optically align the liquid crystal layer, the plane is perpendicular to an optical axis of the first lens, a light-exiting surface of the alignment light source is located in the plane where the focus point is located, and a dimension and shape of the light-exiting surface of the alignment light source are the same as those of a light-exiting surface of the display screen.

At least one embodiment of the present disclosure provides an optical structure, having a light incident side and a light-exiting side, including: a first lens, including a first surface and a second surface which are oppositely disposed, the first surface is a surface of the first lens on the light incident side and the first surface is a curved surface; a transflective film, located on a side of the first surface away from the second surface; a phase retardation layer, located on a side of the second surface away from the first surface; and a polarizing reflective film, located on a side of the phase retardation layer away from the first surface, the phase retardation layer is configured to be coated on the second surface of the first lens, the phase retardation layer includes a liquid crystal layer, orthographic projections of long axis directions of liquid crystal molecules in the liquid crystal layer on a plane perpendicular to an optical axis of the first lens are parallel to each other, the long axis direction of the liquid crystal molecule intersecting the optical axis is perpendicular to the optical axis, in a plane formed by the long axis direction of the liquid crystal molecule and a direction in which the optical axis is located, an included angle between the long axis direction of the liquid crystal molecule and the optical axis becomes smaller and smaller from a central region to an edge region of the first lens.

For example, in the optical structure according to an embodiment of the present disclosure, the phase retardation layer further includes an alignment layer located between the liquid crystal layer and the second surface, the alignment layer is configured to be coated on the second surface of the first lens, the liquid crystal layer is configured to be coated on the alignment layer.

For example, in the optical structure according to an embodiment of the present disclosure, an included angle between the long axis direction of the liquid crystal molecule of the liquid crystal layer and a tangent plane at a position of the liquid crystal molecule on the second surface is in a range from 0 to 40 degrees.

For example, in the optical structure according to an embodiment of the present disclosure, in the plane formed by the long axis direction of the liquid crystal molecule and the direction in which the optical axis is located, the long axis directions of the liquid crystal molecules of the liquid crystal layer have a same deflection trend from the central region to the edge region of the first lens.

For example, in the optical structure according to an embodiment of the present disclosure, an average thickness of the alignment layer is in a range from 30 to 200 nm, and an average thickness of the liquid crystal layer is in a range from 1 to 5 μm.

For example, in the optical structure according to an embodiment of the present disclosure, the second surface of the first lens includes a curved surface.

For example, in the optical structure according to an embodiment of the present disclosure, the second surface of the first lens includes a planar surface, in the plane formed by the long axis direction of the liquid crystal molecule and the direction in which the optical axis is located, a connecting line of centers of the liquid crystal molecules of the liquid crystal layer is not parallel to the second surface, and a center of the connecting line is farther away from the second surface than an edge of the connecting line.

For example, the optical structure according to an embodiment of the present disclosure further including: a second lens, located on a side of the first surface away from the second surface; a second antireflection layer, located on a side of the second lens away from the first lens; a third lens, located on a side of the first lens away from the second lens, including a third surface; a polarizing absorbing layer, located on the third surface of the third lens; and a third antireflection layer, located on a side of the third lens away from the first lens, the polarizing reflective film is located on the third lens and located on a side of the polarizing absorbing layer away from the third surface, a side of the first lens on which the transflective film is formed is bonded with a side of the second lens on which the second antireflection layer is not formed, and a side of the first lens on which the liquid crystal layer is formed is bonded with a side of the third lens on which the third antireflection layer is not formed.

At least one embodiment of the present disclosure provides a display device, including a display screen and the optical structure described above, the display screen is located on the light incident side of the optical structure.

### BRIEF DESCRIPTION OF DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a schematic structural diagram of a pancake lens;

FIG. 2 is a flowchart of a manufacturing method of an optical structure according to an embodiment of the present disclosure;

FIG. 3 is a schematic diagram of optically alignment of a phase retardation layer of an optical structure illustrated by FIG. 2;

FIG. 4 is a schematic view of an optical path of an optical structure of FIG. 2 for display;

FIG. 5 is a schematic cross-sectional view of a liquid crystal layer illustrated by FIG. 2;

FIG. 6 is a schematic view of a projection of liquid crystal molecules of the liquid crystal layer illustrated by FIG. 2 on a plane perpendicular to the optical axis;

FIG. 7 is a flowchart of another manufacturing method of an optical structure according to an embodiment of the present disclosure;

FIG. 8 is a schematic view of an optical structure formed according to the manufacturing method of FIG. 7;

FIG. 9 is a flowchart of another manufacturing method of an optical structure according to an embodiment of the present disclosure;

FIG. 10 is a schematic diagram of optically alignment of a phase retardation layer of an optical structure illustrated by FIG. 9;

FIG. 11 is a schematic view of a partial optical path of an optical structure of FIG. 2 for display at a position of a dotted line frame;

FIG. 12 is a schematic cross-sectional view of a liquid crystal layer illustrated by FIG. 9;

FIG. 13 is a flowchart of another manufacturing method of an optical structure according to an embodiment of the present disclosure;

FIG. 14 is a schematic diagram of optically alignment of a phase retardation layer of an optical structure illustrated by FIG. 13;

FIG. 15 is a flowchart of another manufacturing method of an optical structure according to an embodiment of the present disclosure;

FIG. 16 is a schematic diagram of optically alignment of a phase retardation layer of an optical structure illustrated by FIG. 15;

FIG. 17 shows a schematic cross-sectional view of an optical structure according to an embodiment of the present disclosure;

FIG. 18 shows a schematic cross-sectional view of another optical structure according to an embodiment of the present disclosure;

FIG. 19 shows a schematic cross-sectional view of another optical structure according to an embodiment of the present disclosure;

FIG. 20 shows a schematic cross-sectional view of another optical structure according to an embodiment of the present disclosure;

FIG. 21 is a schematic cross-sectional view of a liquid crystal layer of an optical structure illustrated by FIG. 20;

FIG. 22 shows a schematic cross-sectional view of another optical structure according to an embodiment of the present disclosure;

FIG. 23 is a schematic cross-sectional view of a liquid crystal layer of an optical structure illustrated by FIG. 22; and

FIG. 24 is a schematic diagram of a display device according to an embodiment of the present disclosure.

### DETAILED DESCRIPTION

In order to make the objectives, technical solutions, and advantages of the embodiments of the present disclosure clearer, the technical solutions of the embodiments of the present disclosure will be clearly and completely described below in conjunction with the accompanying drawings of the embodiments of the present disclosure. It is apparent that the described embodiments are part of the embodiments of the present disclosure, not all of the embodiments. Based on the described embodiments of the present disclosure, all other embodiments obtained by those skilled in the art without creative labor are within the scope of protection of the present disclosure.

Unless otherwise defined, technical terms or scientific terms used in this disclosure shall have the usual meaning understood by those of ordinary skill in the art to which this disclosure belongs. The use of the words “first”, “second”, and similar words in this disclosure does not indicate any order, quantity, or importance, but is only used to distinguish different components. The words “including” or “comprising” and similar words mean that the elements or objects appearing before the word cover the elements or objects listed after the word and their equivalents, without excluding other elements or objects.

Unless otherwise defined, the features of “parallel”, “vertical” and “identical” used in the embodiments of the present disclosure include the strict sense of “parallel”, “vertical” and “identical”, as well as the situations involving certain errors such as “substantially parallel”, “substantially vertical” and “substantially identical”. For example, the above-mentioned “substantially” can indicate that the difference value of the compared object is within 10% or 5% of the average value of the compared object. When the number of a component or element is not specifically indicated in the following embodiments of the present disclosure, it means that the component or element can be one or more, or can be understood as at least one. “At least one” refers to one or more, and “more than one” refers to at least two.

Pancake lenses have become the mainstream lens technology for virtual reality and mixed reality near-eye display systems, adopted by various virtual reality and mixed reality near-eye display manufacturers. The pancake lens generally includes a lens and a transflective film, a phase retardation film, a polarizing reflective film, and a polarizing absorbing film formed on the lens. The transflective film may both reflect light and transmit light, for example, the transflective film may be a semi-transmissive and semi-reflective film. The phase retardation film has a fast axis and a slow axis and can change light with a circular polarization state to light with a linear polarization state, or change light with a linear polarization state to light with a circular polarization state. The polarizing reflective film has a reflective axis and a transmissive axis, reflects linearly polarized light in a direction parallel to the reflective axis while keeping the polarization state of the linearly polarized light unchanged, and transmits linearly polarized light in a direction parallel to the transmissive axis while keeping the polarization state of the linearly polarized light unchanged. The polarizing absorbing film has a transmissive axis, a direction of the transmissive axis of the polarizing absorbing film is parallel to the transmissive axis of the polarizing reflective film, and the fast axis of the phase retardation film is at 45° or 135° to the transmissive axis of the polarizing reflective film.

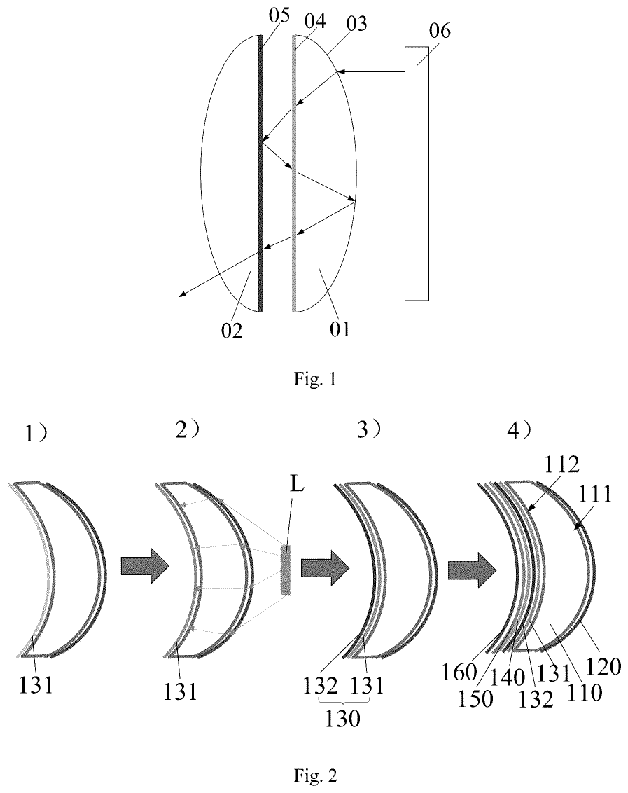

FIG. 1 is a schematic structural diagram of a pancake lens. As illustrated by FIG. 1, the pancake lens includes a lens group formed by a lens 01 and a lens 02, a transflective film 03 and a phase retardation film 04 are formed on the lens 01, and a polarizing reflective film 05 is formed on the lens 02, and light from a display screen 06 passes through the pancake lens to complete folding of the optical path, shortening the space required for the lens group.

Table 1 is a development trend of a pancake lens, corresponding problems, and a general pancake lens to cope with the corresponding problems.

TABLE 1

| | | General pancake |
|---|---|---|
| | Corresponding | lens to cope with |
| Trend | Problems | corresponding problems |
| Optical | Forming a flat | Techniques for |
| films such | precision optical film | combining a lens |
| as a polarizing | on a curved surface | with optical films, |
| reflective | of a lens has | such as: in- |
| film and | high process | mold injection; |
| a phase | difficulty, poor | Optical films having |
| retardation | reliability, it is | a relatively |
| film are | easy to cause the | thin thickness and |
| formed on a | non-uniformity | a relatively high |
| curved | of the optical | degree of cross- |
| surface of | performance of | linking, such as |
| a lens | the optical films, | ultra-thin polarizers, |
| | resulting in poor | polymeric liquid |
| | performance. | crystal type |
| | | polarizers and |
| | | retardation films |
| A number of | When reducing the | Adopting a method |
| lenses is | number of lenses | of adhering |
| reduced by | to a single one, the | lenses, a designed |
| minimizing | phase retardation | single lens is |
| reflective | film may need to | divided into a |
| interfaces | be formed on the | plurality of pieces |
| in the | curved surface of | by a plane or a |
| lenses | the lens, but the | curved surface with |
| | optical and mechanical | a small curvature |
| | properties of the phase | and manufactured |
| | retardation film in the | separately, a phase |
| | existing art are | retardation film |
| | very sensitive to | is bonded to the |
| | stretching | plane or the curved |
| | | surface with a |
| | | small curvature, |
| | | and then adhered |
| | | into a single lens |

As can be seen from the above table, in response to the problems encountered with the trend of the pancake lens, the solution provided by the general pancake lens is more of a compromise. One important reason for this compromise is the physical properties of the phase retardation film, an important optical element within the pancake lens. The pancake lens requires that the phase retardation film maintain its original birefringence properties when formed on the lens surface, whereas the phase retardation film in the existing art inevitably changes its birefringence properties after being formed on the curved surface of the lens.

As a key optical element for the mutual conversion of linearly polarized light and circularly polarized light, the phase retardation film is the key in determining the quality of the pancake lens. An ideal phase retardation film is capable of converting light between completely linearly polarized light (ellipticity=0) and completely circularly polarized light (ellipticity=1), ensuring that all the light from the display panel reaches the human eye following the predetermined folding path. If the phase retardation film deviates from the ideal state, the linearly polarized light passes through the phase retardation film and becomes elliptically polarized light (0<ellipticity<1), and some of the light reaches the human eye without following the predetermined folding path, resulting in ghosting and stray light.

Currently, the phase retardation film applicable to the pancake lens is manufactured by the following two methods: 1) by stretching a macromolecular thin film, the molecules are regularly arranged after stretching, thereby forming a macromolecular phase retardation film having a thickness of about 40 to 60 microns and having birefringent characteristics. 2) By evenly coating a liquid crystal molecule solution on a macromolecular thin film, then aligning the liquid crystal molecules to make them regularly arranged, thus a phase retardation coating is formed with birefringence characteristics and a thickness of about 1 to 5 microns.

In investigation, the inventors of the present application found that both of the phase retardation films manufactured by the above-described method are all provided on the pancake lens by bonding, that is to say, the phase retardation films in a thin film state are bonded to the lens surface by adhesive. This bonding method has the following drawbacks: 1) the optical film is bonded to the lens by adhesive, which is not conducive to the accurate control of flatness. Because the adhesive is soft, it is easy to reflect the uneven stress during bonding on the interface between the film and the adhesive in a rugged form, which affects the imaging and leads to distortion. 2) There are risks in the reliability of bonding soft film and hard lens by adhesive, especially when the bonding interface is curved, which is prone to the common failure problems of the adhesive such as film wrinkle, degumming, foaming and fogging. 3) If the surface of the lens used to bond the phase retardation film is flat, the farther away from the optical axis of the lens, the larger the incident angle of light to the phase retardation film in the designed optical path. However, because of the material characteristics of the phase retardation film, when the light is obliquely incident, the phase retardation characteristics of the phase retardation film may change compared with the normal incidence of light because of the phase retardation Rth in the thickness direction, which makes the ellipticity of obliquely incident polarized light relatively low. Bonding a compensation film (such as positive C film) can compensate for the above-mentioned change of phase retardation because of large angle, but the compensation degree is anisotropic, which only provides complete compensation in a specific direction, and may increase the cost and process difficulty. 4) If the surface of the lens used to bond the phase retardation film is curved, the phase retardation film which is originally a flat film must be stretched if it is perfectly bonded to the curved surface; for the phase retardation film manufactured by the above-mentioned first method, its own phase retardation is obtained by stretching, and an extra stretching in the bonding process may cause the change of retardation, which is likely to be uneven and uncontrollable, which makes the ghost and stray light of pancake uneven and uncontrollable; for the phase retardation film made by the above-mentioned second method, although the variation of retardation caused by stretching is theoretically weaker than the variation of retardation of the first method, the process of transferring and bonding the coating with a thickness of only 1 to 5 microns to the curved surface is very challenging.

Embodiments of the present disclosure provide a manufacturing method of an optical structure. The optical structure has a light incident side and a light-exiting side, the optical structure includes a first lens, a transflective film, a phase retardation layer, and a polarizing reflective film. The first lens includes a first surface and a second surface which are oppositely disposed, the first surface is a surface of the first lens on the light incident side and the first surface is a curved surface, the transflective film is located on a side of the first surface away from the second surface, the phase retardation layer is located on a side of the second surface away from the first surface, and the polarizing reflective film is located on a side of the phase retardation layer away from the first surface, the phase retardation layer includes an alignment layer and a liquid crystal layer, the manufacturing method of the optical structure includes: coating the alignment layer on the second surface of the first lens; using an alignment light source to optically align the alignment layer from the light incident side; coating the liquid crystal layer on a side of the alignment layer away from the second surface.

In the manufacturing method of the optical structure provided by the embodiments of the present disclosure, the alignment layer is coated on the first lens, and the liquid crystal layer is coated on the alignment layer, so that the phase retardation layer can be directly formed on the first lens, there is no need to bond the phase retardation layer to the first lens by adhesive, not only can a process flow of transferring and bonding the phase retardation layer to the first lens be avoided, but also the defects brought by a bonding process can be avoided.

In this embodiment, a molecular structure of the alignment layer is aligned according to light from the alignment light source, the liquid crystal layer is coated on the alignment layer after alignment, a liquid crystal molecule of the liquid crystal layer is arranged according to an alignment direction of the alignment layer, the liquid crystal molecule has a long axis direction and a short axis direction, for example, the long axis direction of the liquid crystal molecule may be arranged according to the alignment direction of the alignment layer, the liquid crystal molecule has different refractive indexes in the long axis direction and the short axis direction, incident light used for display undergoes phase retardation after passing through the phase retardation layer, so that the transformation between linearly polarized light and circularly polarized light can be realized.

The optical structure may be provided with a display screen for display, the display screen emits light from the light incident side through the first surface of the first lens to the phase retardation layer. Light emitted from the alignment light source passes from the light incident side through the first surface of the first lens to the alignment layer, Therefore, an incident angle of light emitted by the alignment light source is close to an incident angle of light emitted by the display screen to a same position on the second surface of the first lens, so that the incident angle of the light emitted by the alignment light source is close to the incident angle of the light used for display at each position of the alignment layer coated on the second surface of the first lens. The liquid crystal layer is coated on the alignment layer after being aligned by the alignment light source, and the liquid crystal molecule is arranged according to the alignment direction of the alignment layer, so that an arrangement direction of the liquid crystal molecule can be better matched with the incident angle of the light used for display, and the phase retardation layer can realize the transformation of light between completely linearly polarized light and completely circularly polarized light as much as possible, and improving the transformation efficiency of completely linearly polarized light and completely circularly polarized light of the phase retardation layer.

Embodiments of the present disclosure provide another manufacturing method of an optical structure. The optical structure is different from the optical structure described above in that the phase retardation layer only includes the liquid crystal layer. The manufacturing method of the optical structure includes: coating the liquid crystal layer on the second surface of the first lens; and using an alignment light source to optically align the alignment layer from the light incident side.

In the manufacturing method of the optical structure provided by the embodiments of the present disclosure, the phase retardation layer is coated on the first lens, there is no need to bond the phase retardation layer to the first lens by adhesive, not only can a process flow of transferring and bonding the phase retardation layer to the first lens be avoided, but also the defects brought by a bonding process can be avoided.

In this example, light emitted from the alignment light source passes from the light incident side through the first surface of the first lens to the alignment layer, Therefore, an incident angle of light emitted by the alignment light source is close to an incident angle of light emitted by the display screen at a same position on the second surface of the first lens, so that the incident angle of the light emitted by the alignment light source is close to the incident angle of the light used for display to each position of the alignment layer coated on the second surface of the first lens. After the liquid crystal layer is aligned by the alignment light source, an arrangement direction of the liquid crystal molecule can be better matched with the incident angle of the light used for display, and the phase retardation layer can realize the transformation of light between completely linearly polarized light and completely circularly polarized light as much as possible, thus improving the transformation efficiency of completely linearly polarized light and completely circularly polarized light of the phase retardation layer.

Embodiments of the present disclosure provide an optical structure. The optical structure has a light incident side and a light-exiting side, the optical structure includes a first lens, a transflective film, a phase retardation layer and a polarizing reflective film. The first lens includes a first surface and a second surface which are oppositely disposed, the first surface is a surface of the first lens on the light incident side of and the first surface being a curved surface; a transflective film is located on a side of the first surface away from the second surface; a phase retardation layer is located on a side of the second surface away from the first surface; a polarizing reflective film is located on a side of the phase retardation layer away from the first surface. The phase retardation layer is configured to be coated on the second surface of the first lens, the phase retardation layer includes a liquid crystal layer, orthographic projections of long axis directions of liquid crystal molecules in the liquid crystal layer on a plane perpendicular to an optical axis of the first lens are parallel to each other, the long axis direction of the liquid crystal molecule intersecting the optical axis is perpendicular to the optical axis, in a plane formed by the long axis direction of the liquid crystal molecule and a direction in which the optical axis is located, an included angle between the long axis direction of the liquid crystal molecule and the optical axis becomes smaller and smaller from a central region to an edge region of the first lens.

In the optical structure provided by embodiments of the present disclosure, the phase retardation layer is configured to be coated on the second surface of the first lens, so that the phase retardation layer can be directly formed on the first lens, there is no need to bond the phase retardation layer to the first lens by adhesive, not only can a process flow of transferring and bonding the phase retardation layer to the first lens be avoided, but also the defects brought by a bonding process can be avoided. In this example, the second surface is a curved surface, however, the embodiment of the present disclosure does not limit thereto.

In this embodiment, a propagation direction of light for display emitted from the light incident side is parallel to the optical axis of the first lens in a direction of the optical axis. Because the first surface of the first lens is a curved surface, an included angle between the propagation direction of the light for display incident on the second surface and the optical axis becomes larger and larger from the central region to the edge region of the first lens in the plane. According to a changing trend of the propagation direction of incident light used for display, by setting the included angle between the long axis direction of the liquid crystal molecule and the optical axis smaller and smaller, the long axis direction of the liquid crystal molecule can always be vertical or nearly vertical to the propagation direction of the incident light, so that the phase retardation layer can realize the transformation of light between completely linearly polarized light and completely circularly polarized light as much as possible, and the transformation efficiency of completely linearly polarized light and completely circularly polarized light in the phase retardation layer is improved.

Hereinafter, the optical structure and the manufacturing method thereof, and the display device provided by the embodiments of the present disclosure will be described in detail in conjunction with the accompanying drawings.

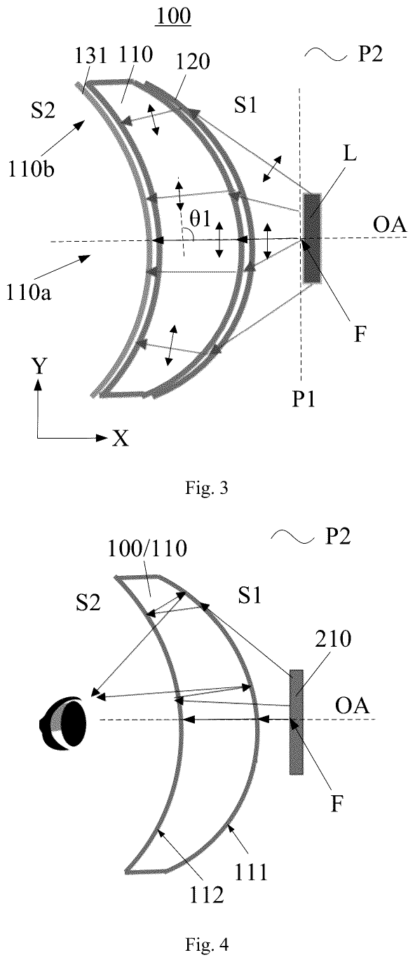

Embodiments of the present disclosure provide a manufacturing method of an optical structure. FIG. 2 is a flowchart of a manufacturing method of an optical structure according to an embodiment of the present disclosure; FIG. 3 is a schematic diagram of optically alignment of a phase retardation layer of an optical structure illustrated by FIG. 2. As illustrated by FIG. 2 and FIG. 3, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111, the phase retardation layer 130 includes an alignment layer 131 and a liquid crystal layer 132, the manufacturing method of the optical structure 100 includes: 1) coating the alignment layer 131 on the second surface 112 of the first lens 110; 2) using an alignment light source L to optically align the alignment layer 131 from the light incident side S1; 3) coating the liquid crystal layer 132 on a side of the alignment layer 131 away from the second surface 112.

In the manufacturing method of the optical structure 100 provided by the embodiments of the present disclosure, the alignment layer 131 is coated on the first lens 110, and the liquid crystal layer 132 is coated on the alignment layer 131, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided. The second surface 112 is a curved surface in this example, however, embodiments of the present disclosure are not limited thereto. For example, the second surface 112 may also be a planar surface.

In this embodiment, a molecular structure of the alignment layer 131 is aligned according to light from the alignment light source L, the liquid crystal layer 132 is coated on the alignment layer 131 after alignment, a liquid crystal molecule of the liquid crystal layer 132 is arranged according to an alignment direction of the alignment layer 131, the liquid crystal molecule has a long axis direction and a short axis direction, for example, the long axis direction of the liquid crystal molecule may be arranged according to the alignment direction of the alignment layer 131, the liquid crystal molecule has different refractive indexes in the long axis direction and the short axis direction, incident light used for display undergoes phase retardation after passing through the phase retardation layer 130, so that the transformation between linearly polarized light and circularly polarized light can be realized.

FIG. 4 is a schematic view of an optical path of an optical structure of FIG. 2 for display. As illustrated by FIGS. 2 and 4, the optical structure 100 may be provided with a display screen 210 for display, the display screen 210 emits light from the light incident side S1 through the first surface 111 of the first lens 110 to the phase retardation layer 130. Light emitted from the alignment light source L passes from the light incident side S1 through the first surface 111 of the first lens 110 to the alignment layer 131, Therefore, an incident angle of light emitted by the alignment light source L is close to an incident angle of light emitted by the display screen 210 to a same position on the second surface 112 of the first lens 110, so that the incident angle of the light emitted by the alignment light source L is close to the incident angle of the light used for display at each position of the alignment layer 131 coated on the second surface 112 of the first lens 110. The liquid crystal layer 132 is coated on the alignment layer 131 after being aligned by the alignment light source L, and the liquid crystal molecule is arranged according to the alignment direction of the alignment layer 131, so that an arrangement direction of the liquid crystal molecule can be better matched with the incident angle of the light used for display, and the phase retardation layer 130 can realize the transformation of light between completely linearly polarized light and completely circularly polarized light as much as possible, and improving the transformation efficiency of completely linearly polarized light and completely circularly polarized light of the phase retardation layer 130. The present disclosure does not limit the kinds of liquid crystal molecules and their arrangement directions. For example, the liquid crystal molecules can be nematic liquid crystals or smectic liquid crystals. For example, the arrangement direction of the liquid crystal molecule may be the long axis direction of the liquid crystal molecule.

For example, as illustrated by FIG. 3, the light emitted by the alignment light source L may be linearly polarized light. For example, a wavelength of the light emitted by the alignment light source L may be such that the alignment layer 131 is optically aligned. The alignment direction of the alignment layer 131 is a polarization direction of the linearly polarized light, and after the liquid crystal layer 132 is coated on the alignment layer 131, the long axis direction of the liquid crystal molecule is arranged according to the alignment direction of the alignment layer 131, that is to say, the long axis direction is perpendicular to a propagation direction of the light incident from the alignment light source L to the phase retardation layer 130. Thus, after the light for display is incident on the phase retardation layer 130, a propagation direction of incident light is perpendicular or nearly perpendicular to the long axis direction of the liquid crystal molecule, and the phase retardation layer 130 can realize the transformation of light between completely linearly polarized light and completely circularly polarized light as much as possible

For example, the alignment light source L may be one or more point light sources or may be a planar light source.

In some examples, as illustrated by FIGS. 2 to 4, when the optical structure 100 is applied to a display device, the light incident side S1 of the optical structure 100 is provided with the display screen 210, the optical structure 100 includes a focal point F located at a position where the display screen 210 is located, using the alignment light source L to optically align the alignment layer 131 from the light incident side S1 includes: using the alignment light source L to emit light from a plane P1 where the focal point F is located to optically align the alignment layer 131, the plane P1 is perpendicular to an optical axis OA of the first lens 110. By using the alignment light source L to emit the light from the plane P1 where the focal point F is located, the incident angle of the light emitted from the alignment light source L is relatively close to the incident angle of the light emitted by the display screen 210 to a same position on the second surface 112 of the first lens 110, so that the arrangement direction of the liquid crystal molecule can be more matched with the light for display, so that the phase retardation layer can realize the transformation of light between completely linearly polarized light and completely circularly polarized light as much as possible. The focal point F in the present disclosure may also be an object focal point of the optical structure.

In some examples, as illustrated by FIGS. 2 to 4, a light-exiting surface of the alignment light source L is located in the plane P1 where the focus point is located, and a dimension and shape of the light-exiting surface of the alignment light source L are the same as those of a light-exiting surface of the display screen 210. Thus, the incident angle of the light emitted by the alignment light source L is the same as the incident angle of the light emitted by the display screen 210 to the same position on the second surface 112 of the first lens 110, and the alignment layer 131 aligned by the alignment light source L can completely match the liquid crystal molecules with the light used for display.

For example, the long axis direction of the liquid crystal molecule is arranged according to the alignment direction of the alignment layer 131, and the propagation direction of the light for display emitted from the display screen 210 is perpendicular to the long axis direction of the liquid crystal molecule at any position of the second surface 112 of the first lens 110, so that the phase retardation layer 130 can achieve a transformation of the light between a completely linearly polarized light and a completely circularly polarized light at any position of the second surface 112 of the first lens 110. Embodiments of the present disclosure do not limit the dimension and shape of the light-exiting surface of the alignment light source, and may be designed according to the dimension and shape of the display screen 210 provided with the optical structure 100.

For example, a diagonal dimension or diameter of the light-exiting surface of the alignment light source L may be 1.3 inches, 1.35 inches, or 1.4 inches. Of course, the embodiments of the present disclosure do not limit the shape, the aspect ratio, or the diameter, etc. of the alignment light source L, and are matched according to the shape, etc., of the actual display screen 210.

In some examples, an area of the light-exiting surface of the alignment light source L is smaller than an area of an orthographic projection of the phase retardation layer 130 on the plane P1.

In some examples, as illustrated by FIGS. 2 and 3, using the alignment light source L to optically align the alignment layer from the light incident side S1 includes: performing optically alignment on the alignment layer 131 from the light incident side S1 by linearly polarized light emitted by the alignment light source L. Of the linearly polarized light emitted from the alignment light source L, the linearly polarized light having a propagation direction coinciding with the optical axis OA of the first lens 110 has a first polarization direction Y, the first polarization direction Y is perpendicular to the optical axis OA, in a plane P2 formed by the first polarization direction Y and a direction X in which the optical axis OA is located, an included angle θ1 between the polarization direction of the linearly polarized light incident on the alignment layer 131 and the optical axis OA becomes smaller and smaller from a central region 110a to an edge region 110b of the first lens 110.

In the present disclosure, within the plane P2, the central region 110a and the edge region 110b are located on a same side of a geometric center of the first lens 110 when it is mentioned that from the central region 110a to the edge region 110b of the first lens 110. The central region 110a of the first lens 110 may refer to a position at the geometric center of the first lens 110. For example, a geometric center of the central region 110a coincides with the geometric center of the first lens 110, a shape of the central region 110a is approximately the same as a shape of the first lens 110 and an area of the central region 110a is less than or equal to 10% of an area of the first lens 110. The edge region 110b of the first lens 110 is located approximately at an outer contour of the first lens 110. For example, the edge region 110b is approximately a same shape as the outer contour of the first lens 110 and forms a closed ring shape along the outer contour of the first lens 110.

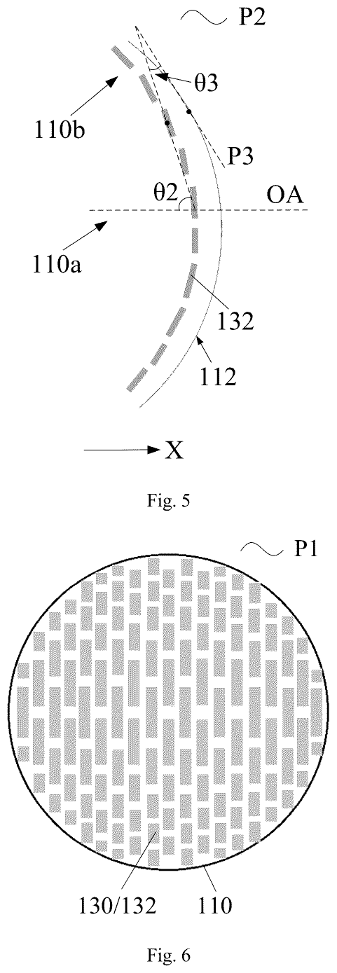

FIG. 5 is a schematic cross-sectional view of a liquid crystal layer illustrated by FIG. 2. As illustrated by FIG. 2 to FIG. 5, after the alignment of the alignment layer 131 is completed using the alignment light source L, the liquid crystal layer 132 is coated on the alignment layer 131, and the liquid crystal molecule of the liquid crystal layer 132 is arranged according to the alignment direction of the alignment layer 131, and the arrangement direction of each liquid crystal molecule is as a direction of a dotted line at the position of the liquid crystal molecule in FIG. 5. For example, the arrangement direction of the liquid crystal molecule may be the long axis direction of the liquid crystal molecule. Thus, on the optical axis OA of the first lens 110, the arrangement direction of the liquid crystal molecule is perpendicular to the optical axis OA. In the plane P2, from the central region 110a to the edge region 110b of the first lens 110, an included angle θ2 between the arrangement direction of the liquid crystal molecule and the optical axis OA becomes smaller and smaller, that is to say, on the second surface 112 of the first lens 110, the arrangement direction of the liquid crystal molecule is not always perpendicular to the optical axis OA, and the arrangement direction of the liquid crystal molecule varies. The propagation direction of the incident light for display from the light incident side S1 of the display screen 210 is parallel to the optical axis OA in a direction of the optical axis OA of the first lens 110, the included angle between them is zero. In the plane P2, because the first surface 111 of the first lens 110 is a curved surface, the included angle between the propagation direction of the incident light for display incident to the second surface 112 and the optical axis OA becomes larger and larger from the central region 110a to the edge region 110b of the first lens 110. Therefore, the change tendency of the arrangement direction of the liquid crystal molecule can be matched with the change tendency of the propagation direction of incident light used for display according to the change tendency of the incident light for display so that the arrangement direction of the liquid crystal molecules is always perpendicular or nearly perpendicular to the propagation direction of the incident light, so that the phase retardation layer 130 can realize the transformation of the light between the completely linearly polarized light and the completely circularly polarized light as much as possible, and the transformation efficiency of the completely linearly polarized light and the completely circularly polarized light of the phase retardation layer 130 is improved. FIG. 5 schematically shows only one sub-layer of the liquid crystal layer 132 and the second surface 112, the liquid crystal layer 132 may include a plurality of sub-layers.

It should be noted that the first polarization direction Y is at 45 degrees or 135 degrees to a transmissive axis direction of the polarizing reflective film 140, and the long axis direction of the liquid crystal molecule on the optical axis OA is at 45 degrees or 135 degrees to the transmissive axis direction of the polarizing reflective film 140.

For example, the long axis direction of the liquid crystal molecule is arranged according to the alignment direction of the alignment layer 131, the long axis direction of the liquid crystal molecule is perpendicular to the incident light for display at the position of the optical axis OA. In the plane P2, from the central region 110a to the edge region 110b of the first lens 110, the included angle θ2 between the long axis direction of the liquid crystal molecule and the optical axis OA is smaller and smaller, and the included angle of the propagation direction of the incident light for display and the optical axis OA is larger and larger. Thus, the long axis direction of the liquid crystal molecule at any position can be perpendicular or nearly perpendicular to the propagation direction of the incident light for display according to the change tendency of the incident light for display.

In some examples, as illustrated by FIGS. 3 and 5, in the plane P2, an included angle θ3 between the long axis direction of the liquid crystal molecule of the liquid crystal layer 132 and a tangent plane P3 at a position of the liquid crystal molecule on the second surface 112 is in a range from 0 to 40 degrees. Thus, the long axis direction of the liquid crystal molecule can be arranged approximately along the second surface 112, and the propagation direction of the incident light from the display screen 210 to the alignment layer through the first surface 111 is approximately perpendicular to the second surface 112, so that the propagation direction of the incident light is approximately perpendicular to the long axis direction of the liquid crystal molecule. Of course, embodiments of the present disclosure do not limit the range of the included angle θ3, and may be matched according to the shape of the first lens 110, the position of the focal point F, and the dimension of the display screen 210.

In some examples, as illustrated by FIG. 5, in the plane P2, from the central region 110a to the edge region 110b of the first lens 110, the long axis directions of the liquid crystal molecules have a same deflection tendency. For example, as illustrated by FIG. 5, the long axis directions of the liquid crystal molecules are all deflected away from the second surface 112. For example, a deflection angle of the long axis direction of the liquid crystal molecule is larger and larger from the center region 110a to the edge region 110b.

In some examples, as illustrated by FIG. 5, an included angle θ3 between the long axis direction of the liquid crystal molecule penetrated by the optical axis OA and the tangent plane P3 corresponding to the liquid crystal molecule is substantially 0 degrees. In the plane P2, the included angle θ3 between the long axis direction of the liquid crystal molecule and the tangent plane P3 corresponding to the liquid crystal molecule is larger and larger from the central region 110a to the edge region 110b of the first lens 110. The included angle θ3 between the long axis direction of the liquid crystal molecule and the tangent plane P3 corresponding to the liquid crystal molecule in the edge region 110b is less than or equal to 40 degrees. Of course, embodiments of the present disclosure do not limit the value of the included angle θ3.

FIG. 6 is a schematic view of a projection of liquid crystal molecules of the liquid crystal layer illustrated by FIG. 2 on a plane perpendicular to the optical axis. As illustrated by FIGS. 2 and 6, orthographic projections of the long axis directions of the liquid crystal molecules of the liquid crystal layer 132 onto the plane P1 perpendicular to the optical axis OA are parallel to each other. A projection length of a long axis of the liquid crystal molecule is smaller and smaller from the central region 110a to the edge region 110b of the first lens 110 along a direction of a projected long axis.

In some examples, as illustrated by FIG. 6, an orthographic projection of the long axis direction of the liquid crystal molecule of the liquid crystal layer 132 on the plane P1 is at 45 degrees or 135 degrees from a transmissive axis direction of the polarizing reflective film 140.

In some examples, as illustrated by FIG. 2, the manufacturing method of the optical structure 100 further includes: 4) sequentially bonding the polarizing reflective film 140, a polarizing absorbing layer 150, and a first antireflection layer 160 on a side of the liquid crystal layer 132 away from the first surface 111.

In some examples, as illustrated by FIG. 2, the manufacturing method of the optical structure 100 further includes: forming a transflective film 120 on the first surface 111 of the first lens 110.

In some examples, as illustrated by FIG. 2, adopting an injection molding method to form a transparent resin lens as the first lens 110. For example, the first surface 111 of the first lens 110 is a convex surface and the second surface 112 is a concave surface.

In some examples, as illustrated by FIG. 2, forming the transflective film 120 on the first surface 111 of the first lens 110 by a coating method. For example, the transflective film 120 may be a semi-transmissive and semi-reflective film, and its reflectivity and transmittance are both 50%. Of course, embodiments of the present disclosure do not limit the transflective film 120, and may be such that the reflectivity is between 30% and 70%, and the corresponding transmittance is between 70% and 30%, according to practical circumstances.

In some examples, as illustrated by FIG. 2, coating and drying to form the alignment lay 131 on the second surface 112 of the first lens 110 by a liquid phase coating method. For example, the liquid phase coating method such as spin coating, dip coating, ultrasonic atomization deposition, ink-jet printing and electrohydrodynamic printing can be adopted. Under the irradiation of polarized light, the alignment layer 131 can undergo anisotropic light response, such as photo-crosslinking orientation to form its own orientation. The liquid crystal layer 132 is coated on the alignment layer 131 after alignment, and the liquid crystal molecules can be arranged according to the orientation of the alignment layer 131.

In some examples, the main chemical composition of the alignment layer 131 may be small molecules or polymers with photosensitivity, for example, the small molecules may be biphenyls, polybiphenyls, azos, etc., having long conjugated structures with correspondence to polarized light. For example, the polymer may be polyvinylcinnamic acids, polycinnamoyloxyethyl methacrylate, polybiphenyls, polypolyphenyls, polyamic acids, polyimides, coumarins, azos, and the like, which are capable of photopolymerizing, photocleaving, or photoisomerizing under polarized light.

In some examples, an average thickness of the alignment layer 131 after alignment is in a range from 30 nm to 200 nm. For example, the average thickness of the alignment layer 131 is in a range from 50 nm to 100 nm. For example, the average thickness of the alignment layer 131 is in a range from 70 nm to 150 nm.

In some examples, as illustrated by FIG. 2, the liquid crystal layer 132 is coated on the alignment layer 131 after alignment in a wet coating method. For example, the wet coating method such as spin coating, flow coating, ultrasonic atomization deposition, ink jet printing, electrofluidic printing, or the like can be employed. For example, an average thickness of the liquid crystal wet film formed by the wet coating method is in a range from 5 to 100 μm.

In some examples, the main chemical composition of the liquid crystal layer 132 may be rod-shaped liquid crystal molecules bearing polymerizable groups, a photopolymerization initiator, a solvent, a cross-linkable resin, etc., with a solid content of 1% to 30% wt. The solvent is capable of dissolving the liquid crystal molecules, the initiator, and the like, and can be, but is not limited to, ketones, alkyl halides, heterocyclic compounds, hydrocarbons, esters, ethers, amides, and the like. The initiator may be a photoinitiator, either one or a mixture of several, in an amount of 0.1% to 10% wt. Embodiments of the present disclosure do not limit the main components of the rod-shaped liquid crystal molecules, and one or more kinds of rod-shaped liquid crystal molecules may be used, preferably liquid crystal molecules having inverse wavelength dispersion characteristics. Examples of the polymerizable groups carried are vinyl groups, acryl groups, methacryl groups, epoxy groups, and the like, and the crosslinking agent may be, but is not limited to, isocyanates, acrylates, methacrylates, epoxies, carbodiimides, amino resins, and the like. The liquid crystal wet film solution is not limited by embodiments of the present disclosure. It should be noted that the process of drying and cross-linking the liquid crystal wet film to obtain the liquid crystal coating does not require a surface light source of a special position and dimension.

For example, an average thickness of a cross-linked liquid crystal layer 132 or liquid crystal dry film is in a range from 1 to 5 μm. For example, the average thickness can be any value within 1 to 5 μm.

In some examples, the polarizing reflective film 140, sequentially bonding the polarizing reflective film 140, a polarizing absorbing layer 150, and a first antireflection layer 160 on a side of the liquid crystal layer 132 away from the first surface 111 by a method of stretching bonding or thermoforming bonding. Embodiments of the present disclosure do not limit the polarizing reflective film 140, the polarizing absorbing layer 150, and the first antireflection layer 160.

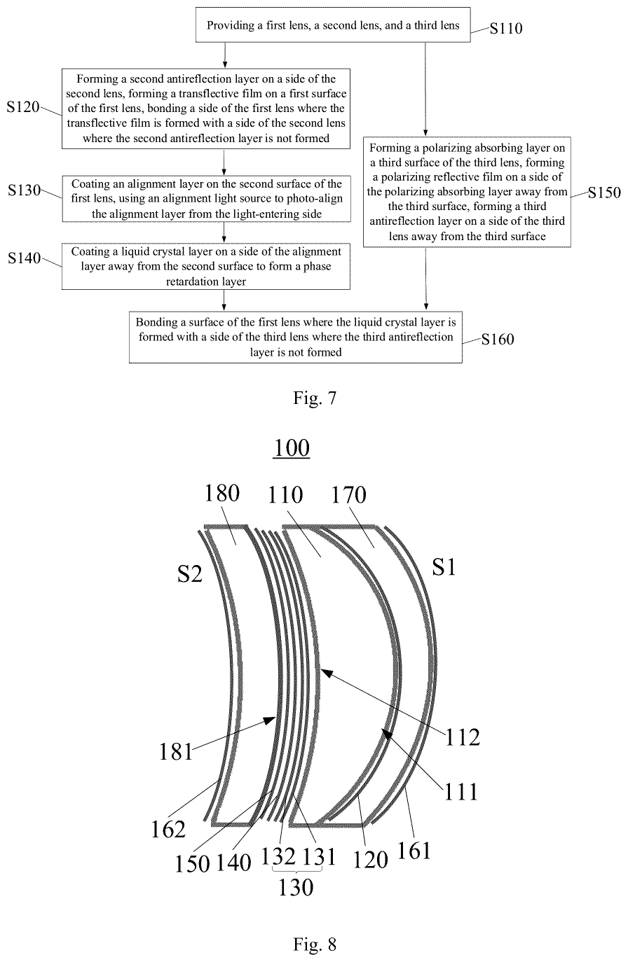

FIG. 7 is a flowchart of another manufacturing method of an optical structure according to an embodiment of the present disclosure; FIG. 8 is a schematic view of an optical structure formed according to the manufacturing method of FIG. 7. As illustrated by FIGS. 7 and 8, the manufacturing method of the optical structure 100 includes:
S110: providing a first lens 110, a second lens 170, and a third lens 180;
S120: forming a second antireflection layer 161 on a side of the second lens 170, forming a transflective film 120 on a first surface 111 of the first lens 110, bonding a side of the first lens 110 where the transflective film 120 is formed with a side of the second lens 170 where the second antireflection layer 161 is not formed;
S130: coating an alignment layer 131 on the second surface 112 of the first lens 110, using an alignment light source to optically align the alignment layer 131 from the light incident side S1;
S140: coating a liquid crystal layer 132 on a side of the alignment layer 131 away from the second surface 112 to form a phase retardation layer 130;
S150: forming a polarizing absorbing layer 150 on a third surface 181 of the third lens 180, forming a polarizing reflective film 140 on a side of the polarizing absorbing layer 150 away from the third surface 181, forming a third antireflection layer 162 on a side of the third lens 180 away from the third surface 181;
S160: bonding a surface of the first lens 110 where the liquid crystal layer 132 is formed with a side of the third lens 180 where the third antireflection layer 162 is not formed.

The embodiment of the present disclosure does not limit the sequence of each step, and can be adjusted according to the actual situation.

In some examples, as illustrated by FIGS. 7 and 8, adopting injection molding method to form transparent resin lenses as the first lens 110, the second lens 170, and the third lens 180. For example, the first surface 111 of the first lens 110 is a convex surface and the second surface 112 is a concave surface.

In some examples, as illustrated by FIGS. 7 and 8, the light-exiting surface of the alignment light source is located at a position of a display screen to which the optical structure 100 formed by the first lens 110, the second lens 170, and the third lens 180 is matched. For example, the dimension and shape of the light-exiting surface of the alignment light source is the same as those of the light-exiting surface of the display screen.

In some examples, before forming the third antireflection layer 162 on the side of the third lens 180 away from the third surface 181, performing a hardening processing on the side of the third lens 180 away from the third surface 181, so that the product performance of the optical structure 100 may be better improved.

In some examples, the optical structure 100 may also include two or more lenses, the manufacturing process of the optical structure 100 is referred to above and will not be repeated.

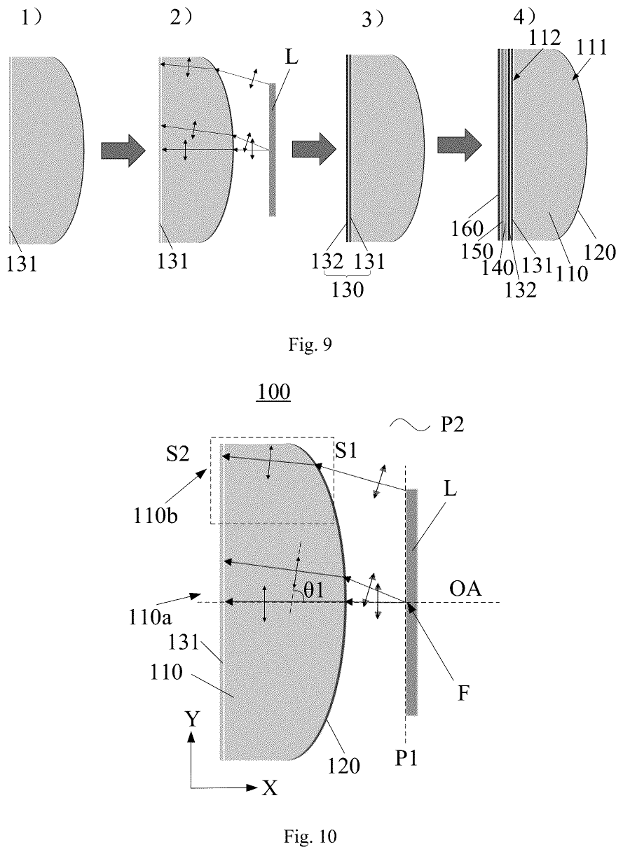

FIG. 9 is a flowchart of another manufacturing method of an optical structure according to an embodiment of the present disclosure; FIG. 10 is a schematic diagram of optically alignment of a phase retardation layer of an optical structure illustrated by FIG. 9. As illustrated by FIGS. 9 and 10, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111, the phase retardation layer 130 includes an alignment layer 131 and a liquid crystal layer 132, the manufacturing method of the optical structure 100 includes: 1) coating the alignment layer 131 on the second surface 112 of the first lens 110; 2) using an alignment light source L to optically align the alignment layer 131 from the light incident side S1; 3) coating the liquid crystal layer 132 on a side of the alignment layer 131 away from the second surface 112.

In the manufacturing method of the optical structure 100 provided by the embodiments of the present disclosure, the alignment layer 131 is coated on the first lens 110, and the liquid crystal layer 132 is coated on the alignment layer 131, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided.

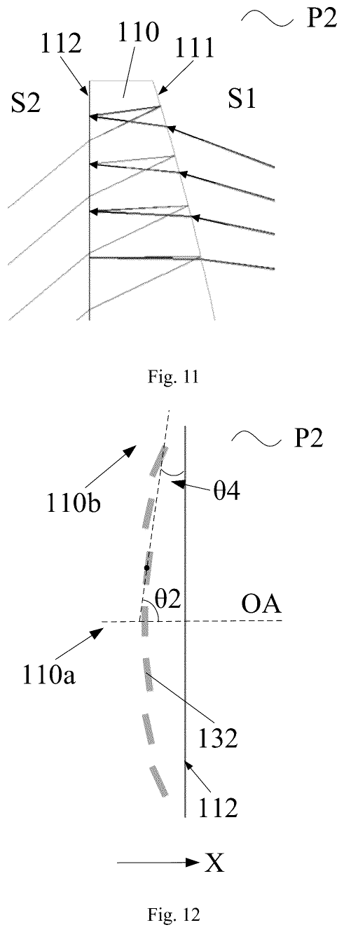

FIG. 11 is a schematic view of a partial optical path of an optical structure of FIG. 2 for display at a position of a dotted line frame. As illustrated by FIGS. 10 and 11, the second surface 112 of the first lens 110 of the optical structure 100 is a planar surface. When light emitted from a display screen passes from the light incident side S1 through the first surface 111 of the first lens 110 to the second surface 112, the propagation direction of the incident light is not always perpendicular to the second surface 112. On the optical axis OA of the first lens 110, the propagation direction of the incident light is perpendicular to the second surface 112, and in the plane P2, the included angle between the propagation direction of the incident light with the second surface 112 is smaller and smaller from the central region 110a to the edge region 110b of the first lens 110. The light emitted from the alignment light source L passes from the light incident side S1 through the first surface 111 of the first lens 110 to the alignment layer 131, therefore, the incident angle of light emitted by the alignment light source L is close to the incident angle of light emitted by the display screen to a same position on the second surface 112 of the first lens 110, so that the incident angle of the light emitted by the alignment light source L is close to the incident angle of the light used for display at each position of the alignment layer 131 coated on the second surface 112 of the first lens 110. The liquid crystal layer 132 is coated on the alignment layer 131 after being aligned by the alignment light source L, and the liquid crystal molecule is arranged according to the alignment direction of the alignment layer 131, so that an arrangement direction of the liquid crystal molecule can be better matched with the incident angle of the light used for display, and the phase retardation layer 130 can realize the transformation of light between completely linearly polarized light and completely circularly polarized light as much as possible, and improving the transformation efficiency of completely linearly polarized light and completely circularly polarized light of the phase retardation layer 130. For example, the arrangement direction of the liquid crystal molecule may be the long axis direction of the liquid crystal molecule.

In some examples, as illustrated by FIGS. 9 to 11, when the optical structure 100 is applied to a display device, the light incident side S1 of the optical structure 100 is provided with the display screen, the optical structure 100 includes a focal point F located at a position where the display screen is located, using the alignment light source L to optically align the alignment layer 131 from the light incident side S1 includes: using the alignment light source L to emit light from a plane P1 where the focal point F is located to optically align the alignment layer 131, the plane P1 is perpendicular to an optical axis OA of the first lens 110. By using the alignment light source L to emit the light from the plane P1 where the focal point F is located, the incident angle of the light emitted from the alignment light source L is relatively close to the incident angle of the light emitted by the display screen 210 to a same position on the second surface 112 of the first lens 110, so that the arrangement direction of the liquid crystal molecule can be more matched with the light for display, so that the phase retardation layer can realize the transformation of light between completely linearly polarized light and completely circularly polarized light as much as possible. For example, the arrangement direction of the liquid crystal molecule may be the long axis direction of the liquid crystal molecule, and the propagation directions of the light emitted from the display screen for display are all perpendicular to the long axis directions of the liquid crystal molecules.

In some examples, as illustrated by FIGS. 9 to 11, the light-exiting surface of the alignment light source L is located in the plane P1 where the focus point is located, and the dimension and shape of the light-exiting surface of the alignment light source L are the same as those of the light-exiting surface of the display screen 210. Thus, the incident angle of the light emitted by the alignment light source L is the same as the incident angle of the light emitted by the display screen 210 to the same position on the second surface 112 of the first lens 110, and the alignment layer 131 aligned by the alignment light source L can completely match the liquid crystal molecules with the light used for display.

In some examples, as illustrated by FIGS. 9 to 11, using the alignment light source L to optically align the alignment layer from the light incident side S1 includes: performing optically alignment on the alignment layer 131 from the light incident side S1 by linearly polarized light emitted by the alignment light source L. Of the linearly polarized light emitted from the alignment light source L, the linearly polarized light having the propagation direction coinciding with the optical axis OA of the first lens 110 has the first polarization direction Y, the first polarization direction Y is perpendicular to the optical axis OA, in the plane P2 formed by the first polarization direction Y and the direction X in which the optical axis OA is located, the included angle θ1 between the polarization direction of the linearly polarized light incident on the alignment layer 131 and the optical axis OA becomes smaller and smaller from a central region 110a to an edge region 110b of the first lens 110. Thus, the liquid crystal layer arranged by the alignment light source L can be better matched with the light for display, so that the phase retardation layer 130 can realize the transformation of the light between the completely linearly polarized light and the completely circularly polarized light as much as possible.

FIG. 12 is a schematic cross-sectional view of a liquid crystal layer illustrated by FIG. 9. As illustrated in FIGS. 9 and 12, in the plane P2, from the central region 110a to the edge region 110b of the first lens 110, the included angle θ2 between the long axis direction of the liquid crystal molecule with the optical axis OA becomes smaller and smaller. Referring to FIG. 11, from the central region 110a to the edge region 110b of the first lens 110, the included angle between the propagation direction of the incident light for display and the optical axis OA is larger and larger, Thus, the long axis direction of the liquid crystal molecule in any position can be perpendicular or nearly perpendicular to the propagation direction of the incident light for display according to the change tendency of the incident light for display. FIG. 12 schematically shows only one sub-layer of the liquid crystal layer 132 and the second surface 112, the liquid crystal layer 132 may include a plurality of sub-layers.

In some examples, as illustrated by FIGS. 9 and 12, in the plane P2, an included angle θ4 between the long axis direction of the liquid crystal molecule of the liquid crystal layer 132 and the second surface 112 is in a range from 0 to 40 degrees. The included angle θ4 between the long axis direction of the liquid crystal molecule 132 penetrated by the optical axis OA and the second surface 112 is zero. In the plane P2, the included angle θ4 between the long axis direction of the liquid crystal molecule and the second surface 112 is larger and larger from the central region 110a to the edge region 110b of the first lens 110. At the edge position, the included angle θ4 between the long axis direction of the liquid crystal molecule and the second surface 112 is less than or equal to 40 degrees. Of course, embodiments of the present disclosure do not limit the range of the included angle θ4, and may be matched according to the shape of the first lens 110, the position of the focal point F, and the dimension of the display screen 210.

In some examples, as illustrated in FIG. 12, in the plane P2, from the central region 110a to the edge region 110b of the first lens 110, the long axis directions of the liquid crystal molecules have a same deflection tendency. For example, as illustrated by FIG. 12, the long axis directions of the liquid crystal molecules are all deflected toward the second surface 112, and a deflection angle of the long axis direction of the liquid crystal molecule toward the second surface 112 is larger and larger from the center region 110a to the edge region 110b.

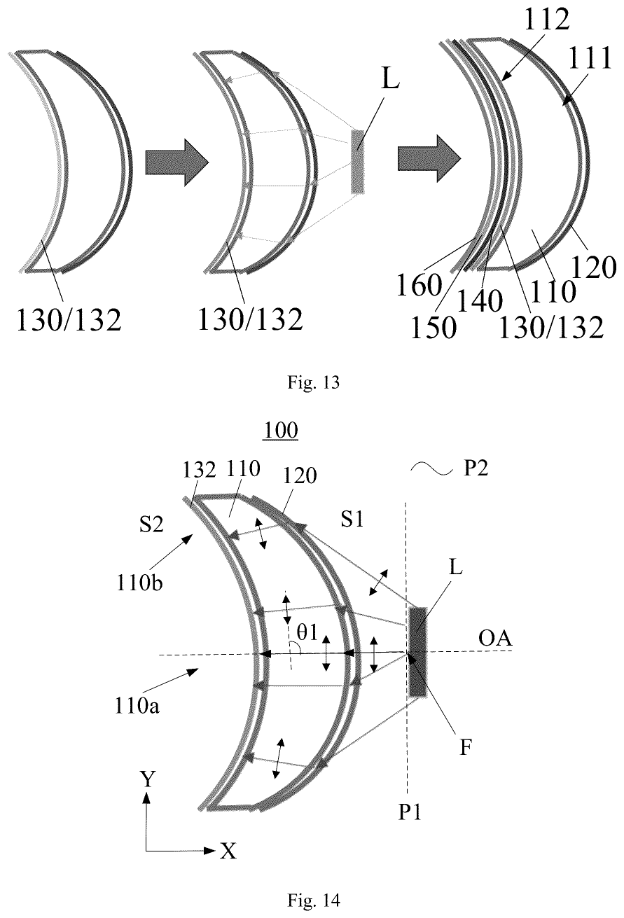

FIG. 13 is a flowchart of another manufacturing method of an optical structure according to an embodiment of the present disclosure; FIG. 14 is a schematic diagram of optically alignment of a phase retardation layer of an optical structure illustrated by FIG. 13. As illustrated by FIGS. 13 and 14, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111, the phase retardation layer 130 includes a liquid crystal layer 132, the manufacturing method of the optical structure 100 includes: 1) coating the liquid crystal layer 132 on the second surface 112 of the first lens 110; 2) using an alignment light source L to optically align the liquid crystal layer 132 from the light incident side S1.

In the manufacturing method of the optical structure 100 provided by the embodiments of the present disclosure, the liquid crystal layer 132 is coated on the first lens 110, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided. The second surface 112 is a curved surface in this example, however, embodiments of the present disclosure are not limited thereto. For example, the second surface 112 may also be a planar surface.

In this example, the liquid crystal layer 132 may be formed by a liquid crystal molecule that can achieve alignment under external excitation. For example, the liquid crystal layer 132 may adopt the optically alignment. Referring to FIG. 4, the optical structure 100 may be provided with a display screen 210 for display, the display screen 210 emits light from the light incident side S1 through the first surface 111 of the first lens 110 to the phase retardation layer 130. Light emitted from the alignment light source L passes from the light incident side S1 through the first surface 111 of the first lens 110 to the liquid crystal layer 132, Therefore, an incident angle of light emitted by the alignment light source L is close to an incident angle of light emitted by the display screen 210 to a same position on the second surface 112 of the first lens 110, so that the incident angle of the light emitted by the alignment light source L is close to the incident angle of the light used for display at each position of the liquid crystal layer 132 coated on the second surface 112 of the first lens 110, After the liquid crystal layer 132 is aligned by the alignment light source L, an arrangement direction of the liquid crystal molecule can be better matched with the incident angle of the light used for display, and the phase retardation layer 130 can realize the transformation of light between completely linearly polarized light and completely circularly polarized light as much as possible, and improving the transformation efficiency of completely linearly polarized light and completely circularly polarized light of the phase retardation layer 130. For example, the arrangement direction of the liquid crystal molecule may be the long axis direction of the liquid crystal molecule.

In some examples, as illustrated by FIGS. 4, 13, and 14, when the optical structure 100 is applied to a display device, the light incident side S1 of the optical structure 100 is provided with the display screen, the optical structure 100 includes a focal point F located at a position where the display screen is located, using the alignment light source L to optically align the liquid crystal layer 132 from the light incident side S1 includes: using the alignment light source L to emit light from a plane P1 where the focal point F is located to optically align the liquid crystal layer 132, the plane P1 is perpendicular to an optical axis OA of the first lens 110. By using the alignment light source L to emit the light from the plane P1 where the focal point F is located, the incident angle of the light emitted from the alignment light source L is relatively close to the incident angle of the light emitted by the display screen 210 to a same position on the second surface 112 of the first lens 110, so that the arrangement direction of the liquid crystal molecule can be more matched with the light for display, so that the phase retardation layer can realize the transformation of light between completely linearly polarized light and completely circularly polarized light as much as possible.

In some examples, as illustrated by FIGS. 13 and 14, a light-exiting surface of the alignment light source L is located in the plane P1 where the focus point is located, and a dimension and shape of the light-exiting surface of the alignment light source L are the same as those of a light-exiting surface of the display screen 210. Thus, the incident angle of the light emitted by the alignment light source L is the same as the incident angle of the light emitted by the display screen 210 to the same position on the second surface 112 of the first lens 110, and the liquid crystal layer 132 aligned by the alignment light source L can completely match the liquid crystal molecules with the light used for display.

In some examples, as illustrated by FIGS. 13 and 14, using the alignment light source L to optically align the liquid crystal layer 132 from the light incident side S1 includes: performing optically alignment on the liquid crystal layer 132 from the light incident side S1 by linearly polarized light emitted by the alignment light source L. Of the linearly polarized light emitted from the alignment light source L, the linearly polarized light having a propagation direction coinciding with the optical axis OA of the first lens 110 has a first polarization direction Y, the first polarization direction Y is perpendicular to the optical axis OA, in a plane P2 formed by the first polarization direction Y and a direction X in which the optical axis OA is located, an included angle 01 between the polarization direction of the linearly polarized light incident on the liquid crystal layer 132 and the optical axis OA becomes smaller and smaller from a central region 110a to an edge region 110b of the first lens 110.

In some examples, the arrangement of the liquid crystal molecule of the liquid crystal layer is the same as illustrated by FIGS. 5 and 6, and will not be described in detail herein.

In some examples, as illustrated by FIG. 13, the manufacturing method of the optical structure 100 further includes: 3) sequentially bonding the polarizing reflective film 140, a polarizing absorbing layer 150, and a first antireflection layer 160 on a side of the liquid crystal layer 132 away from the first surface 111. For example, the manufacturing method of the optical structure 100 further includes: forming a transflective film 120 on the first surface 111 of the first lens 110.

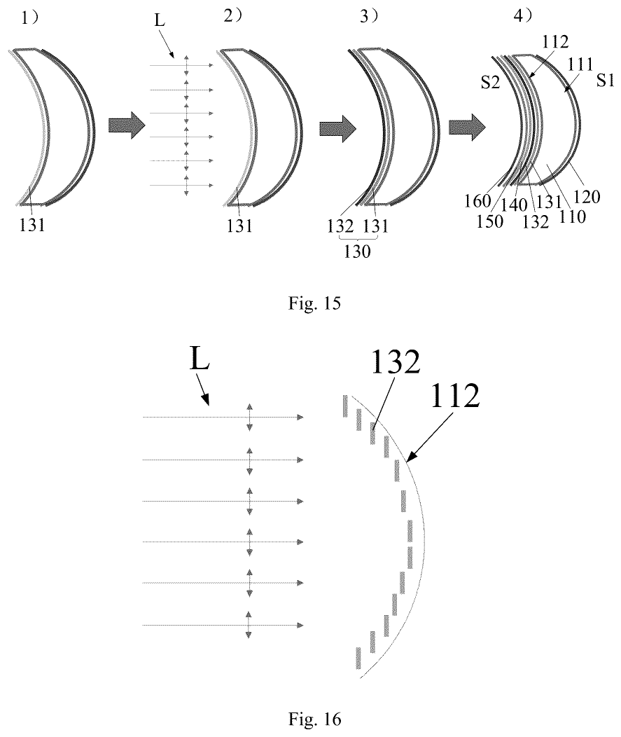

FIG. 15 is a flowchart of another manufacturing method of an optical structure according to an embodiment of the present disclosure; FIG. 16 is a schematic diagram of optically alignment of a phase retardation layer of an optical structure illustrated by FIG. 15. As illustrated by FIGS. 15 and 16, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111, the phase retardation layer 130 includes an alignment layer 131 and a liquid crystal layer 132, the manufacturing method of the optical structure 100 includes: 1) coating the alignment layer 131 on the second surface 112 of the first lens 110; 2) using an alignment light source L to optically align the alignment layer 131 from the light-exiting side S2; 3) coating the liquid crystal layer 132 on a side of the alignment layer 131 away from the second surface 112.

In the manufacturing method of the optical structure 100 provided by the embodiments of the present disclosure, the alignment layer 131 is coated on the first lens 110, and the liquid crystal layer 132 is coated on the alignment layer 131, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided. The second surface 112 is a curved surface in this example, however, embodiments of the present disclosure are not limited thereto. For example, the second surface 112 may also be a planar surface. FIG. 16 schematically shows only one sub-layer of the liquid crystal layer 132 and the second surface 112, the liquid crystal layer 132 may include a plurality of sub-layers.

In some examples, as illustrated by FIGS. 15 and 16, the light emitted by the alignment light source L can be linearly polarized light having a polarization direction that is 45 degrees or 135 degrees from the transmissive axis of the polarizing reflective film 140.

For example, the alignment direction of the alignment layer 131 is parallel to the polarization direction of the linearly polarized light. For example, the long axis direction of the liquid crystal molecule is arranged according to the alignment direction of the alignment layer 131.

In some examples, as illustrated by FIG. 15, the manufacturing method of the optical structure 100 further includes: 4) sequentially bonding the polarizing reflective film 140, a polarizing absorbing layer 150, and a first antireflection layer 160 on a side of the liquid crystal layer 132 away from the first surface 111. For example, the manufacturing method of the optical structure 100 further includes: forming a transflective film 120 on the first surface 111 of the first lens 110.

In some examples, the phase retardation layer 130 of the optical structure 100 illustrated by FIG. 15 may also include only the liquid crystal layer 132, and the manufacturing method of the optical structure 100 includes: 1) coating the liquid crystal layer 132 on the second surface 112 of the first lens 110; 2) using an alignment light source L to optically align the liquid crystal layer 132 from the light-exiting side S2; 3) sequentially bonding the polarizing reflective film 140, a polarizing absorbing layer 150, and a first antireflection layer 160 on a side of the liquid crystal layer 132 away from the first surface 111.

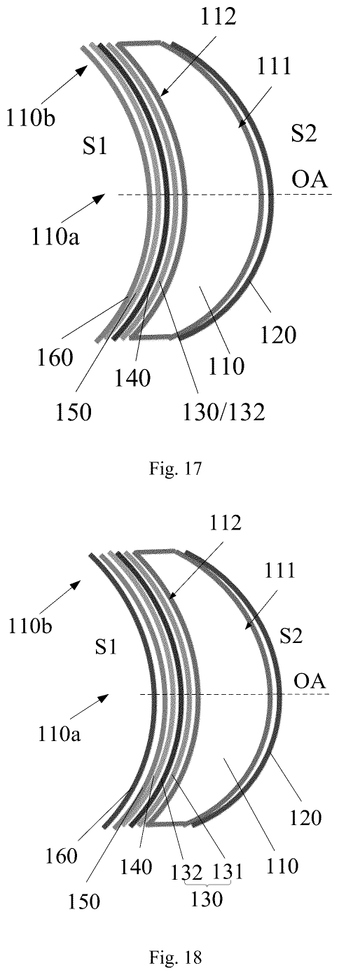

Embodiments of the present disclosure provide an optical structure. FIG. 17 shows a schematic cross-sectional view of an optical structure according to an embodiment of the present disclosure. As illustrated by FIG. 5, FIG. 6, and FIG. 17, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111. The phase retardation layer 130 is configured to be coated on the second surface 112 of the first lens 110, the phase retardation layer 130 includes a liquid crystal layer 132, orthographic projections of long axis directions of liquid crystal molecules in the liquid crystal layer 132 on a plane P1 perpendicular to an optical axis OA of the first lens 110 are parallel to each other, the long axis direction of the liquid crystal molecule intersecting the optical axis OA is perpendicular to the optical axis OA, in a plane P2 formed by the long axis direction of the liquid crystal molecule and a direction X in which the optical axis OA is located, an included angle θ2 between the long axis direction of the liquid crystal molecule and the optical axis OA becomes smaller and smaller from a central region 110a to an edge region 110b of the first lens 110.

In the optical structure 100 provided by embodiments of the present disclosure, the phase retardation layer 130 is configured to be coated on the second surface 112 of the first lens 110, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided. The second surface 112 is a curved surface in this example, however, embodiments of the present disclosure are not so limited. For example, the second surface 112 may also be a planar surface.

In this embodiment, referring to FIG. 4, the propagation direction of the light for display emitted from the light incident side S1 is parallel to the optical axis OA of the first lens 110 on the optical axis OA, and because the first surface 111 of the first lens 110 is a curved surface, the angle of the propagation direction of the light for display incident on the second surface 112 with the optical axis OA is larger and larger from the central area 110a to the edge area 110b of the first lens 110 within the plane P2. By setting the angle θ2 between the long axis direction of the liquid crystal molecule and the optical axis OA to be smaller and smaller in accordance with the tendency of the propagation direction of incident light for display, the long axis direction of the liquid crystal molecule can always be perpendicular or nearly perpendicular to the propagation direction of the incident light, so that the phase retardation layer 130 can realize as much as possible the transformation of the light between the completely linearly polarized light and the completely circularly polarized light, and the transformation efficiency of the completely linearly polarized light and the completely circularly polarized light of the phase retardation layer 130 is improved.

In some examples, the liquid crystal layer 132 may be formed by liquid crystal molecules capable of achieving alignment under external excitation (e.g., light, electric field, surface energy, shear force, etc.). For example, the liquid crystal layer 132 may adopt optically alignment. For example, the liquid crystal layer 132 can be aligned by the manufacturing method of the optical structure 100 described above. Of course, the embodiment of the present disclosure does not limit the alignment mode of the liquid crystal layer 132.

In some examples, as illustrated by FIGS. 5 and 17, in the plane P2, an included angle θ3 between the long axis direction of the liquid crystal molecule of the liquid crystal layer 132 and a tangent plane P3 at a position of the liquid crystal molecule on the second surface 112 is in a range from 0 to 40 degrees. Thus, the long axis direction of the liquid crystal molecule can be arranged approximately along the second surface 112. The propagation direction of the light for display incident on the phase retardation layer 130 through the first surface 111 is approximately perpendicular to the second surface 112, so that the propagation direction of the incident light is approximately perpendicular to the long axis direction of the liquid crystal molecule. Of course, embodiments of the present disclosure do not limit the range of the included angle θ3, and may be matched according to the shape of the first lens 110, the position of the focal point F, and the dimension of the display screen 210.

In some examples, as illustrated by FIGS. 5 and 17, in the plane P2, from the central region 110a to the edge region 110b of the first lens 110, the long axis directions of the liquid crystal molecules have a same deflection tendency. For example, as illustrated by FIG. 5, the long axis directions of the liquid crystal molecules are all deflected away from the second surface 112. For example, a deflection angle of the long axis direction of the liquid crystal molecule is larger and larger from the center region 110a to the edge region 110b.

In some examples, as illustrated by FIGS. 5 and 17, on the optical axis OA, the included angle θ3 between the long axis direction of the liquid crystal molecule and the tangent plane P3 corresponding to the liquid crystal molecule is 0 degrees. In the plane P2, the included angle θ3 between the long axis direction of the liquid crystal molecule and the tangent plane P3 corresponding to the liquid crystal molecule is larger and larger from the central region 110a to the edge region 110b of the first lens 110. At an edge position, the included angle θ3 between the long axis direction of the liquid crystal molecule and the tangent plane P3 corresponding to the liquid crystal molecule in the edge region 110b is less than or equal to 40 degrees. Of course, embodiments of the present disclosure do not limit the value of the included angle θ3.

In some examples, as illustrated by FIGS. 6 and 17, orthographic projections of the long axis directions of the liquid crystal molecules of the liquid crystal layer 132 onto the plane P1 perpendicular to the optical axis OA are parallel to each other, a projection length of a long axis of the liquid crystal molecule is smaller and smaller from the central region 110a to the edge region 110b of the first lens 110 along a direction of a projected long axis.

In some examples, the orthographic projection of the long axis direction of the liquid crystal molecule of the liquid crystal layer 132 on the plane P1 is at 45 degrees or 135 degrees from the transmissive axis direction of the polarizing reflective film 140.

In some examples, as illustrated by FIG. 17, the optical structure 100 further includes a polarizing absorbing layer 150 and a first antireflection layer 160 sequentially located on a side of the polarizing reflective film 140 away from the phase retardation layer 130.

FIG. 18 shows a schematic cross-sectional view of another optical structure according to an embodiment of the present disclosure. As illustrated by FIG. 18, the phase retardation layer 130 of the optical structure 100 further includes an alignment layer 131 located between the liquid crystal layer 132 and the second surface 112, the alignment layer 131 is configured to be coated on the second surface 112 of the first lens 110, the liquid crystal layer 132 is configured to be coated on the alignment layer 131. The liquid crystal layer 132 is coated on the alignment layer 131, so that the alignment of the liquid crystal layer 132 can be realized through the alignment layer 131. For example, the alignment layer 131 can adopt the optically alignment, and the liquid crystal layer 132 can be arranged along the alignment direction of the alignment layer 131 after being coated on the alignment layer 131 already aligned. For example, the alignment layer 131 can be aligned by the manufacturing method of the optical structure 100 described above. Of course, the embodiment of the present disclosure does not limit the alignment mode of the alignment layer 131.

In some examples, the alignment layer 131 has an average thickness of 30 to 200 nm. For example, the average thickness of the liquid crystal layer 132 is in a range from 1 to 5 μm.

In some examples, as illustrated by FIG. 8, the optical structure 100 further includes a second lens 170, a third lens 180, a polarizing absorbing layer 150, a second antireflection layer 161, and a third antireflection layer 162. The second lens 170 is located on a side of the first surface 111 away from the second surface 112, the second antireflection layer 161 is located on a side of the second lens 170 away from the first lens 110, and a side of the first lens 110 on which the transflective film 120 is formed is bonded with a side of the second lens 170 on which the second antireflection layer 161 is not formed. The third lens 180 is located on a side of the first lens 110 away from the second lens 170, the third lens 180 includes a third surface 181, the polarizing absorbing layer 150 is located on the third surface 181 of the third lens 180, and the polarizing reflective film 140 is located on the third lens 180 and on a side of the polarizing absorbing layer 150 away from the third surface 181. The third antireflection layer 162 is positioned on a side of the third lens 180 away from the first lens 110, and a side of the first lens 110 on which the liquid crystal layer 132 is formed is bonded with a side of the third lens 180 on which the third antireflection layer 162 is not formed. In this example, a number of lenses can be increased or decreased according to the optical requirements or performance requirements of the optical structure 100, and a number of optical films can also be increased or decreased. For example, the optical structure 100 may also include two lenses or more lenses. For example, the side of the third lens 180 away from the first lens 110 may be coated with a hardening layer or the like.

FIG. 8 schematically illustrates that the phase retardation layer 130 includes the alignment layer 131 and the liquid crystal layer 132, however, embodiments of the present disclosure are not limited thereto, and the phase retardation layer 130 may include only the liquid crystal layer 132.

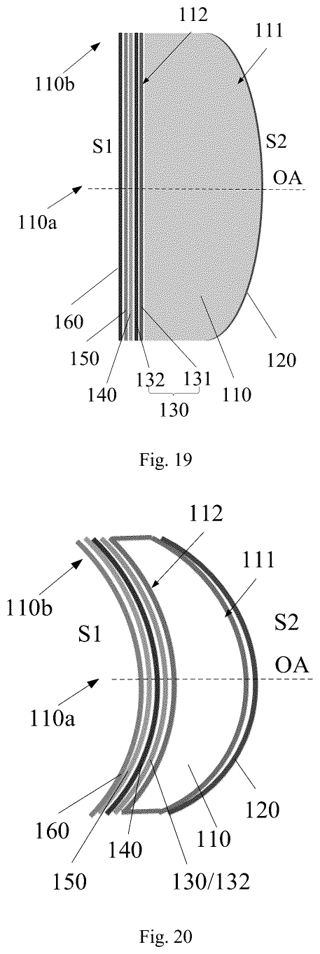

FIG. 19 shows a schematic cross-sectional view of another optical structure according to an embodiment of the present disclosure. As illustrated by FIG. 12 and FIG. 19, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111. The phase retardation layer 130 is configured to be coated on the second surface 112 of the first lens 110, the phase retardation layer 130 includes an alignment layer 131 and a liquid crystal layer 132, the alignment layer 131 is configured to be coated on the second surface 112 of the first lens 110, and the liquid crystal layer 132 is configured to be coated on the alignment layer 131. Orthographic projections of long axis directions of liquid crystal molecules in the liquid crystal layer 132 on a plane P1 perpendicular to an optical axis OA of the first lens 110 are parallel to each other, the long axis direction of the liquid crystal molecule intersecting the optical axis OA is perpendicular to the optical axis OA, in a plane P2 formed by the long axis direction of the liquid crystal molecule and a direction X in which the optical axis OA is located, an included angle θ2 between the long axis direction of the liquid crystal molecule and the optical axis OA becomes smaller and smaller from a central region 110a to an edge region 110b of the first lens 110. The orthographic projection of the long axis direction of the liquid crystal molecule of the liquid crystal layer 132 illustrated by FIG. 19 on the plane P1 refers to FIG. 6, and will not be repeatedly explained here.

In the optical structure 100 provided by embodiments of the present disclosure, the phase retardation layer 130 is configured to be coated on the second surface 112 of the first lens 110, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided. The second surface 112 is curved in this example, however, embodiments of the present disclosure are not limited thereto.

In the optical structure 100 provided by an embodiment of the present disclosure, the second surface 112 is a planar surface, with reference to the optical path diagram illustrated by FIG. 11, when light emitted from a display screen passes from the light incident side S1 through the first surface 111 of the first lens 110 to the second surface 112, the propagation direction of the incident light is not always perpendicular to the second surface 112. On the optical axis OA of the first lens 110, the propagation direction of the incident light is perpendicular to the second surface 112, and the included angle between the propagation direction of the incident light with the second surface 112 is smaller and smaller from the central region 110a to the edge region 110b of the first lens 110. By setting the angle θ2 between the long axis direction of the liquid crystal molecule and the optical axis OA to be smaller and smaller in accordance with the tendency of the propagation direction of incident light for display, the long axis direction of the liquid crystal molecule can always be perpendicular or nearly perpendicular to the propagation direction of the incident light, so that the phase retardation layer 130 can realize as much as possible the transformation of the light between the completely linearly polarized light and the completely circularly polarized light, and the transformation efficiency of the completely linearly polarized light and the completely circularly polarized light of the phase retardation layer 130 is improved.

FIG. 19 schematically shows that the phase retardation layer 130 includes the alignment layer 131 and the liquid crystal layer 132. However, embodiments of the present disclosure are not limited thereto, and the phase retardation layer 130 may also include only the liquid crystal layer 132 configured to be coated on the second surface 112 of the first lens 110, which is not described in detail herein.

In some examples, as illustrated by FIGS. 12 and 19, in the plane P2, the included angle θ4 between the long axis direction of the liquid crystal molecule of the liquid crystal layer 132 and the second surface 112 is in a range from 0 to 40 degrees.

In some examples, as illustrated by FIGS. 12 and 19, in the plane P2, the included angle θ4 between the long axis direction of the liquid crystal molecule and the second surface 112 is 0 degrees on the optical axis OA. In the plane P2, the included angle θ4 between the long axis direction of the liquid crystal molecule and the second surface 112 is larger and larger from the central region 110a to the edge region 110b of the first lens 110. At the edge position, the included angle θ4 between the long axis direction of the liquid crystal molecule and the second surface 112 is less than or equal to 40 degrees. Of course, embodiments of the present disclosure do not limit the range of the included angle θ4, and may be matched according to the shape of the first lens 110, the position of the focal point F, and the dimension of the display screen 210.

In some examples, as illustrated in FIGS. 12 and 19, in the plane P2, from the central region 110a to the edge region 110b of the first lens 110, the long axis directions of the liquid crystal molecules have a same deflection tendency. For example, the long axis directions of the liquid crystal molecules are all deflected toward the second surface 112 from the central region 110a to the edge region 110b of the first lens 110, and an deflection angle of the long axis direction of the liquid crystal molecule toward the second surface 112 is larger and larger from the center region 110a to the edge region 110b.

In some examples, as illustrated by FIGS. 12 and 19, in the plane P2, a connecting line of centers of the liquid crystal molecules of the liquid crystal layer 132 is not parallel to the second surface 112, and a center of the connecting line is farther away from the second surface 112 than an edge of the connecting line. It should be noted that the connecting line is a connecting line of liquid crystal molecules in one sub-layer in the figure, the center of the connecting line is on the optical axis OA and the edge of the connecting line is on the edge region 110b of the first lens 110.

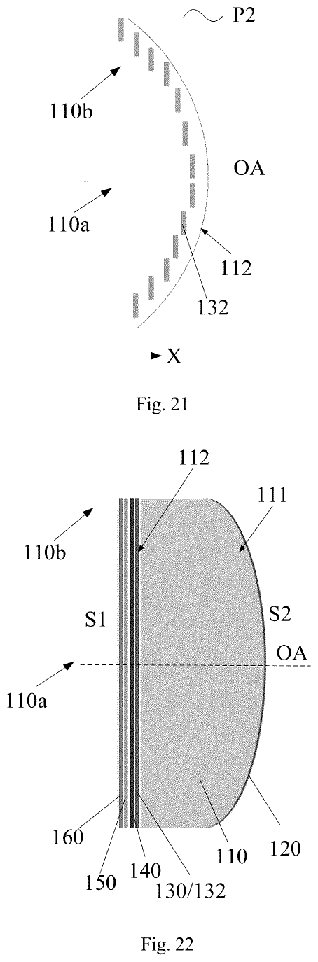

FIG. 20 shows a schematic cross-sectional view of another optical structure according to an embodiment of the present disclosure; FIG. 21 is a schematic cross-sectional view of a liquid crystal layer of an optical structure illustrated by FIG. 20. As illustrated by FIGS. 20 and 21, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111. The phase retardation layer 130 is configured to be coated on the second surface 112 of the first lens 110, the phase retardation layer 130 includes a liquid crystal layer 132, long axis directions of liquid crystal molecules in the liquid crystal layer 132 are parallel to each other. A plane P2 is a plane formed by the long axis direction of the liquid crystal molecule and the direction X in which the optical axis OA is located.

In the optical structure 100 provided by embodiments of the present disclosure, the phase retardation layer 130 is configured to be coated on the second surface 112 of the first lens 110, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided. FIG. 21 schematically shows only one sub-layer of the liquid crystal layer 132 and the second surface 112, the liquid crystal layer 132 may include a plurality of sub-layers.

In this example, the phase retardation layer 130 includes the liquid crystal layer 132, however, the phase retardation layer 130 may further include an alignment layer 131 configured to be coated on the second surface 112 of the first lens 110, the liquid crystal layer 132 is configured to be coated on the alignment layer 131.

For example, the long axis direction of the liquid crystal molecule is at 45 degrees or 135 degrees to the transmissive axis of the polarizing reflective film 140.

For example, the liquid crystal layer 132 may be aligned using the manufacturing method of the embodiment corresponding to FIG. 15 described above.

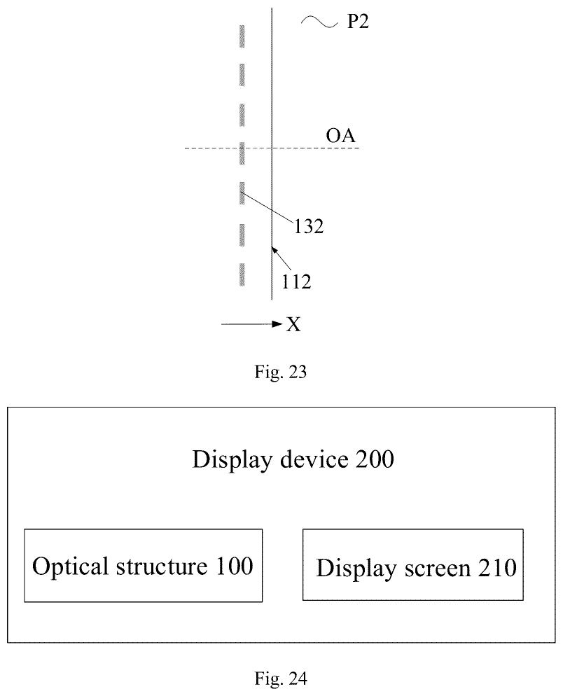

FIG. 22 shows a schematic cross-sectional view of another optical structure according to an embodiment of the present disclosure; FIG. 23 is a schematic cross-sectional view of a liquid crystal layer of an optical structure illustrated by FIG. 22. As illustrated by FIGS. 22 and 23, the optical structure 100 has a light incident side S1 and a light-exiting side S2, and the optical structure 100 includes a first lens 110, a transflective film 120, a phase retardation layer 130, and a polarizing reflective film 140. The first lens 110 includes a first surface 111 and a second surface 112 which are oppositely disposed, the first surface 111 is a surface of the first lens 110 on the light incident side S1 and the first surface 111 is a curved surface, a transflective film 120 is located on a side of the first surface 111 away from the second surface 112, a phase retardation layer 130 is located on a side of the second surface 112 away from the first surface 111, a polarizing reflective film 140 is located on a side of the phase retardation layer 130 away from the first surface 111. The phase retardation layer 130 is configured to be coated on the second surface 112 of the first lens 110, the phase retardation layer 130 includes a liquid crystal layer 132, long axis directions of liquid crystal molecules in the liquid crystal layer 132 are parallel to each other. A plane P2 is a plane formed by the long axis direction of the liquid crystal molecule and the direction X in which the optical axis OA is located.

In the optical structure 100 provided by embodiments of the present disclosure, the phase retardation layer 130 is configured to be coated on the second surface 112 of the first lens 110, so that the phase retardation layer 130 can be directly formed on the first lens 110, there is no need to bond the phase retardation layer 130 to the first lens 110 by adhesive, not only can a process flow of transferring and bonding the phase retardation layer 130 to the first lens 110 be avoided, but also the defects brought by a bonding process can be avoided. FIG. 23 schematically shows only one sub-layer of the liquid crystal layer 132 and the second surface 112, the liquid crystal layer 132 may include a plurality of sub-layers.

In this example, the phase retardation layer 130 includes the liquid crystal layer 132, however, the phase retardation layer 130 may further include an alignment layer 131 configured to be coated on the second surface 112 of the first lens 110, the liquid crystal layer 132 is configured to be coated on the alignment layer 131.

For example, the long axis direction of the liquid crystal molecule is at 45 degrees or 135 degrees to the transmissive axis of the polarizing reflective film 140.

For example, the liquid crystal layer 132 may be aligned using the manufacturing method of the embodiment corresponding to FIG. 15 described above.

An embodiment of the present disclosure provides a display device. FIG. 24 is a schematic diagram of a display device according to an embodiment of the present disclosure. As illustrated by FIG. 24, the display device 200 includes a display screen 210 and any of the optical structures 100 described above, the display screen 210 is located on the light incident side of the optical structure 100. Thus, the display device 200 has advantageous effects corresponding to advantageous effects of the optical module, which will not be described in detail herein.

For example, the display device 200 may be a virtual reality (VR) or mixed reality (MR) near-eye display device 200.

There are several points which should be noted.
(1) In the drawings of the embodiments of the present disclosure, only the structures involved in the embodiments of the present disclosure are involved. Other structures can refer to the usual design.
(2) The features in the same embodiment and different embodiments of the present disclosure can be combined with each other without conflict.

The above are only the specific implementations of the present disclosure, but the scope of protection of the present disclosure is not limited thereto. Any person skilled in the art can easily conceive of variations or substitutions within the technical scope disclosed in the present disclosure, which should be included in the scope of protection of the present disclosure. Therefore, the scope of protection of the present disclosure shall be based on the scope of protection of the claims.

1. A manufacturing method of an optical structure, wherein the optical structure has a light incident side and a light-exiting side, the optical structure comprises a first lens, a transflective film, a phase retardation layer, and a polarizing reflective film, the first lens comprises a first surface and a second surface which are oppositely disposed, the first surface is a surface of the first lens on the light incident side and the first surface is a curved surface, the transflective film is located on a side of the first surface away from the second surface, the phase retardation layer is located on a side of the second surface away from the first surface, and the polarizing reflective film is located on a side of the phase retardation layer away from the first surface,
wherein the phase retardation layer comprises an alignment layer and a liquid crystal layer, the manufacturing method comprises:
coating the alignment layer on the second surface of the first lens;
using an alignment light source to optically align the alignment layer from the light incident side; and
coating the liquid crystal layer on a side of the alignment layer away from the second surface.

2. The manufacturing method according to claim 1, wherein when the optical structure is applied to a display device, a display screen is provided on the light incident side of the optical structure, and the optical structure comprises a focal point located at a position where the display screen is located,
wherein using the alignment light source to optically align the alignment layer from the light incident side comprises:
using the alignment light source to emit light from a plane where the focal point is located to optically align the alignment layer, wherein the plane is perpendicular to an optical axis of the first lens.

3. The manufacturing method according to claim 2, wherein a light-exiting surface of the alignment light source is located in the plane where the focus point is located, and a dimension and shape of the light-exiting surface of the alignment light source are the same as those of a light-exiting surface of the display screen.

4. The manufacturing method according to claim 2, wherein an area of a light-exiting surface of the alignment light source is smaller than an area of an orthographic projection of the phase retardation layer on the plane.

5. The manufacturing method according to claim 1, wherein using the alignment light source to optically align the alignment layer from the light incident side comprises:
performing optical alignment on the alignment layer from the light incident side by linearly polarized light emitted by the alignment light source,
wherein a part of the linearly polarized light whose propagation direction coincides with an optical axis of the first lens has a first polarization direction, the first polarization direction is perpendicular to the optical axis, in a plane formed by the first polarization direction and a direction in which the optical axis is located, an included angle between the polarization direction of the linearly polarized light incident on the alignment layer and the optical axis becomes smaller and smaller from a central region to an edge region of the first lens.

6. The manufacturing method according to claim 1, wherein an included angle between a long axis direction of a liquid crystal molecule of the liquid crystal layer and a tangent plane at a position of the liquid crystal molecule on the second surface is in a range from 0 to 40 degrees.

7. The manufacturing method according to claim 1, wherein an average thickness of the alignment layer is in a range from 30 to 200 nm, and an average thickness of the liquid crystal layer is in a range from 1 to 5 μm.

8. The manufacturing method according to claim 1, wherein the second surface of the first lens comprises a curved surface or a planar surface.

9. The manufacturing method according to claim 1, further comprising:
forming the transflective film on the first surface of the first lens;
forming the polarizing reflective film on a side of the liquid crystal layer away from the first surface;
forming a polarizing absorbing layer on a side of the polarizing reflective film away from the first surface; and
forming a first antireflection layer on a side of the polarizing absorbing layer away from the first surface.

10. The manufacturing method according to claim 1, further comprising:
providing a second lens and a third lens;
forming a second antireflection layer on a side of the second lens;
forming the transflective film on the first surface of the first lens;
bonding a side of the first lens where the transflective film is formed with a side of the second lens where the second antireflection layer is not formed;
forming a polarizing absorbing layer on a third surface of the third lens;
forming the polarizing reflective film on a side of the polarizing absorbing layer away from the third surface;
forming a third antireflection layer on a side of the third lens away from the third surface; and
bonding a surface of the first lens where the liquid crystal layer is formed with a side of the third lens where the third antireflection layer is not formed.

11. A manufacturing method of an optical structure, wherein the optical structure has a light incident side and a light-exiting side, the optical structure comprises a first lens, a transflective film, a phase retardation layer, and a polarizing reflective film, the first lens comprises a first surface and a second surface which are oppositely disposed, the first surface is a surface of the first lens on the light incident side and the first surface is a curved surface, the transflective film is located on a side of the first surface away from the second surface, the phase retardation layer is located on a side of the second surface away from the first surface, and the polarizing reflective film is located on a side of the phase retardation layer away from the first surface,
wherein the phase retardation layer comprises a liquid crystal layer, the manufacturing method comprises:
coating the liquid crystal layer on the second surface of the first lens; and
using an alignment light source to optically align the liquid crystal layer from the light incident side.

12. The manufacturing method according to claim 11, wherein when the optical structure is applied to a near-eye display device, a display screen is provided on the light incident side of the optical structure, and the optical structure comprises a focal point located at a position where the display screen is located,
wherein using the alignment light source to optically align the liquid crystal layer from the light incident side comprises: using the alignment light source to emit light from a plane where the focus point is located to optically align the liquid crystal layer,
wherein the plane is perpendicular to an optical axis of the first lens, a light-exiting surface of the alignment light source is located in the plane where the focus point is located, and a dimension and shape of the light-exiting surface of the alignment light source are the same as those of a light-exiting surface of the display screen.

13. An optical structure, having a light incident side and a light-exiting side, comprising:
a first lens, comprising a first surface and a second surface which are oppositely disposed, wherein the first surface is a surface of the first lens on the light incident side and the first surface is a curved surface;
a transflective film, located on a side of the first surface away from the second surface;
a phase retardation layer, located on a side of the second surface away from the first surface; and
a polarizing reflective film, located on a side of the phase retardation layer away from the first surface,
wherein the phase retardation layer is configured to be coated on the second surface of the first lens, the phase retardation layer comprises a liquid crystal layer, orthographic projections of long axis directions of liquid crystal molecules in the liquid crystal layer on a plane perpendicular to an optical axis of the first lens are parallel to each other,
the long axis direction of the liquid crystal molecule intersecting the optical axis is perpendicular to the optical axis, in a plane formed by the long axis direction of the liquid crystal molecule and a direction in which the optical axis is located, an included angle between the long axis direction of the liquid crystal molecule and the optical axis becomes smaller and smaller from a central region to an edge region of the first lens.

14. The optical structure according to claim 13, wherein the phase retardation layer further comprises an alignment layer located between the liquid crystal layer and the second surface, the alignment layer is configured to be coated on the second surface of the first lens, the liquid crystal layer is configured to be coated on the alignment layer.

15. The optical structure according to claim 13, wherein an included angle between the long axis direction of the liquid crystal molecule of the liquid crystal layer and a tangent plane at a position of the liquid crystal molecule on the second surface is in a range from 0 to 40 degrees.

16. The optical structure according to claim 13, wherein in the plane formed by the long axis direction of the liquid crystal molecule and the direction in which the optical axis is located, the long axis directions of the liquid crystal molecules of the liquid crystal layer have a same deflection trend from the central region to the edge region of the first lens.

17. The optical structure according to claim 14, wherein an average thickness of the alignment layer is in a range from 30 to 200 nm, and an average thickness of the liquid crystal layer is in a range from 1 to 5 μm.

18. The optical structure according to claim 13, wherein the second surface of the first lens comprises a planar surface,
in the plane formed by the long axis direction of the liquid crystal molecule and the direction in which the optical axis is located, a connecting line of centers of the liquid crystal molecules of the liquid crystal layer is not parallel to the second surface, and a center of the connecting line is farther away from the second surface than an edge of the connecting line.

19. The optical structure according to claim 13, further comprising:
a second lens, located on a side of the first surface away from the second surface;
a second antireflection layer, located on a side of the second lens away from the first lens;
a third lens, located on a side of the first lens away from the second lens, comprising a third surface;
a polarizing absorbing layer, located on the third surface of the third lens; and
a third antireflection layer, located on a side of the third lens away from the first lens,
wherein the polarizing reflective film is located on the third lens and located on a side of the polarizing absorbing layer away from the third surface, a side of the first lens on which the transflective film is formed is bonded with a side of the second lens on which the second antireflection layer is not formed, and a side of the first lens on which the liquid crystal layer is formed is bonded with a side of the third lens on which the third antireflection layer is not formed.

20. A display device, comprising a display screen and the optical structure according to claim 13, wherein the display screen is located on the light incident side of the optical structure.
